(19) United States
(12) Patent Application Publication
(10) Pub. No.: US 2005/0129139 A1
(43) Pub. Date: Jun. 16, 2005

(54) Tag tracking

(76) Inventors: Aled Wynne Jones, Harston (GB); Roger Williamson, Harston (GB); Michael Reynolds, Harston (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/985,000

(22) Filed: Nov. 10, 2004

(30) Foreign Application Priority Data
Dec. 3, 2003 (GB) 0328046.8

(51) Int. Cl. H04B 1/69

(52) U.S. Cl. 375/295

(57) ABSTRACT

A tracking system is described in which a mobile tag having an unknown position is tracked in space over time. The mobile tag transmits a signal comprising a sequence of frequency components at different frequencies. The transmitted signal is received at each of a plurality of receivers, each having a known location. Each of the receivers measures the phase of each of the tones and the phase measures are passed to a central processing unit. The central processing unit then uses the determined phase measures to determine the position of the tag at the time of the transmission. Various novel tag arrangements are described which generate new transmission signals which improve accuracy and reliability of the position measurements obtained.

This invention relates to a method and apparatus used in systems for tracking moving objects. The invention has particular but not exclusive relevance to the tracking of competitors of a race using electronic tags which are carried by the competitors and which transmit signals that are detected by a tracking system.

There is a requirement for a system to track the movement of competitors in a race or similar sporting event to provide movement data for use in race reconstruction and simulation services. Sporting events of interest include for example, horse racing, dog racing, motor racing, golf etc. Such a tracking system requires any device to be carried on or by the competitors in the racing event to be as small and light and unobtrusive as possible so as not to impede the competitors in the race or event. Also, in order to reduce costs and operating difficulties, any RF signals used by the system would preferably be within a frequency band in which no licence is required and in a band in which transmission is permitted. Further, the position accuracy should be sufficient that the data generated accurately describes the position of the competitors relative to one another. The tracking range of the system must also be able to cover the size of the venue at which the racing event is to take place.

WO 02/41029 and WO 03/016940 describe a tag tracking system in which one or more movable tags transmit signals to a number of fixed receivers. The tags are arranged to transmit a sequence of frequency tones and the receivers determine phase measurements for each of the tones and from these phase measurements determines the position of the movable tags.

The present invention aims to provide alternative arrangements to those described in these International applications.

According to one aspect, the mobile tags are arranged to transmit a novel transmission signal structure. In a preferred form, the transmission signal includes a temporal sequence of frequency components with the duration of the frequency components having the greatest frequency separation therebetween is longer than the duration of the or each other frequency component in the sequence.

According to another aspect, the invention provides another racing transmitter which is arranged to transmit pairs of pulses of transmission signal, in which the time interval between the pulses of a pair is less than the time interval between adjacent pairs of pulses.

In a yet further aspect, the invention provides a racing transmitter for generating pulses of transmission signal, with each pulse including first and second sequences of frequency components, with the frequency components in the first sequence being different to the frequency components in the second sequence and with the frequency components in the first sequence being the same within adjacent pulses and with the frequency components in the second sequence being different in adjacent pulses.

The inventors have found that the novel racing transmitters discussed above offer advantages in the positioning system in relation to the accurate determination of phase measures for the transmission signals and for the more accurate calculation of calibration values.

Various other advantageous features and aspects of the present invention will become apparent from the following detailed description of examples and embodiments which are described with reference to the accompanying drawings in which:

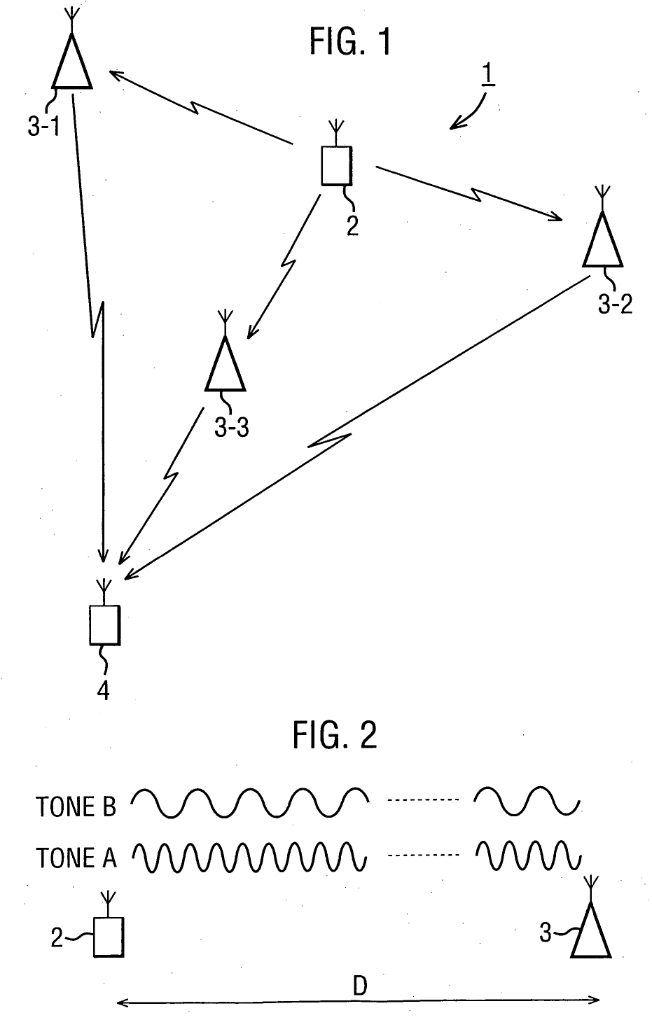

FIG. 1 is a schematic drawing showing a tracking system of a first example for tracking the position of a moving object;

FIG. 2 is a schematic diagram showing two tone signals and their respective phases between a tag transmitter and a receiver of the system shown in FIG. 1;

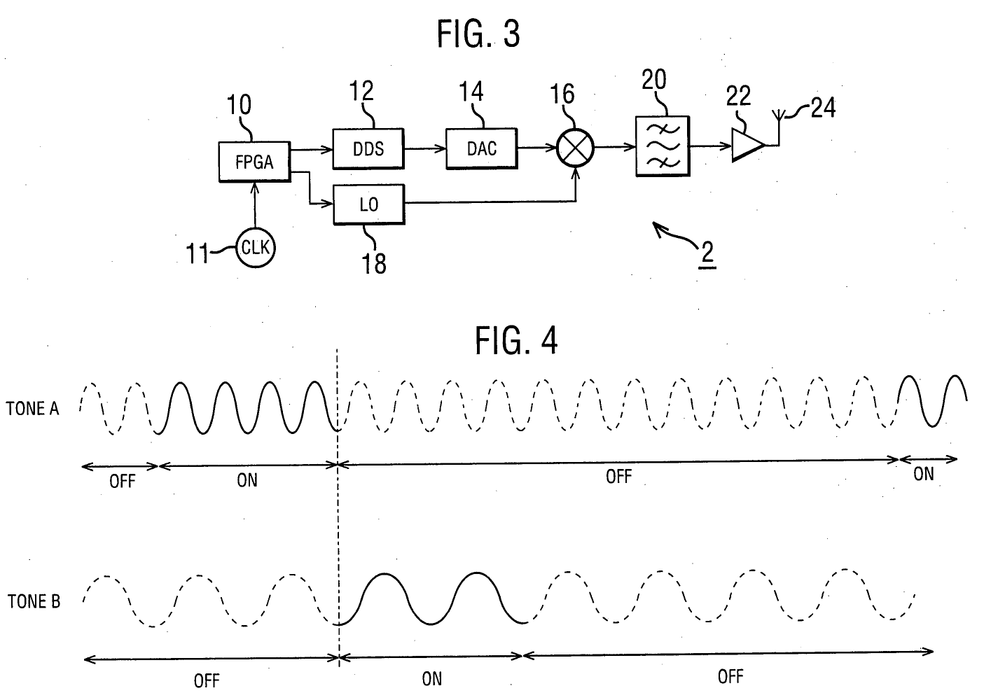

FIG. 3 is a block diagram showing the functional elements of the tag transmitter used in the first example;

FIG. 4 is a timing diagram illustrating the way in which the tag shown in FIG. 3 outputs the two tone transmit signal;

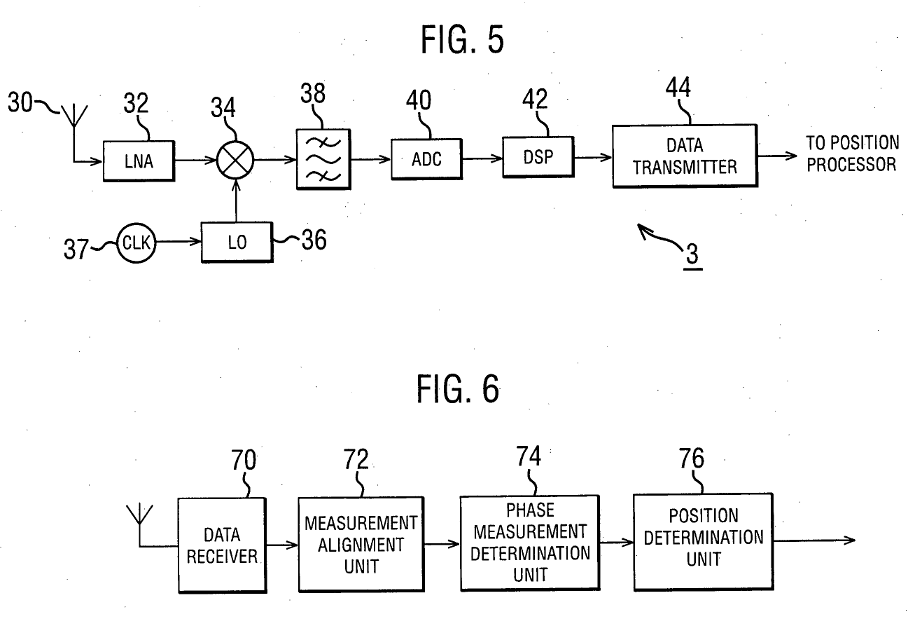

FIG. 5 is a block diagram showing the functional elements of the receiver used in the first example;

FIG. 6 is a block diagram showing the functional elements of a position processor used in the first example to process the signals received from all of the receivers to determine the current position of the moveable object;

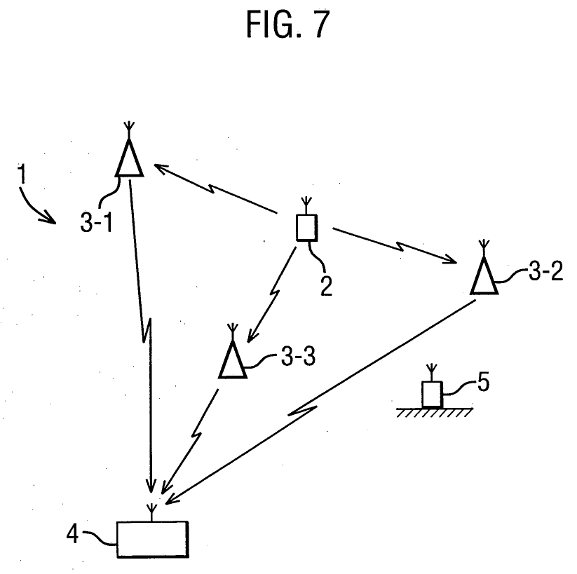

FIG. 7 is a schematic diagram showing a tracking system of a second example for tracking the position of a moving object;

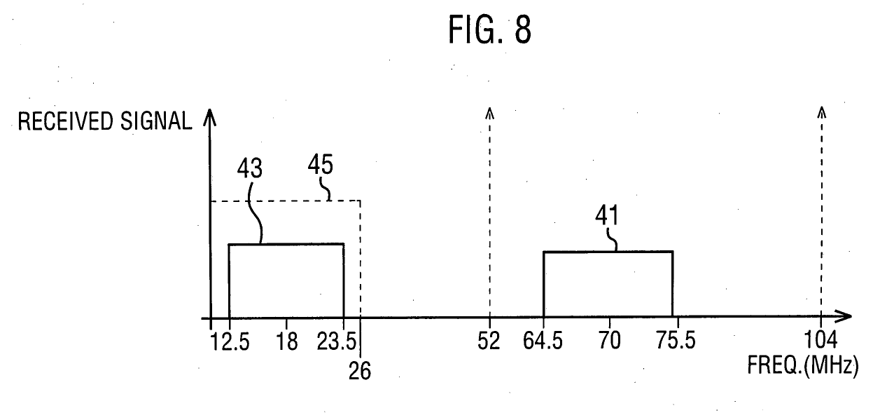

FIG. 8 is a graphical representation of the sampling process used by the DSP of the receiver used in the second example;

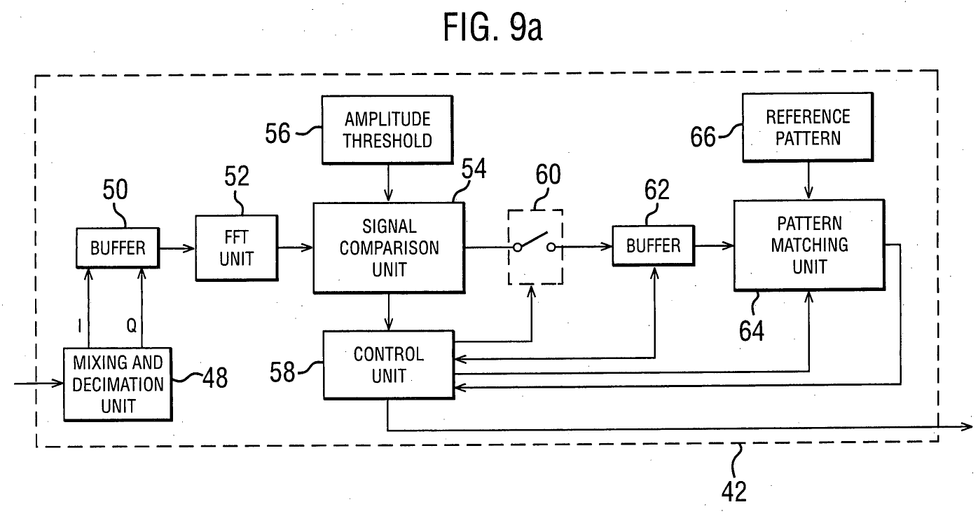

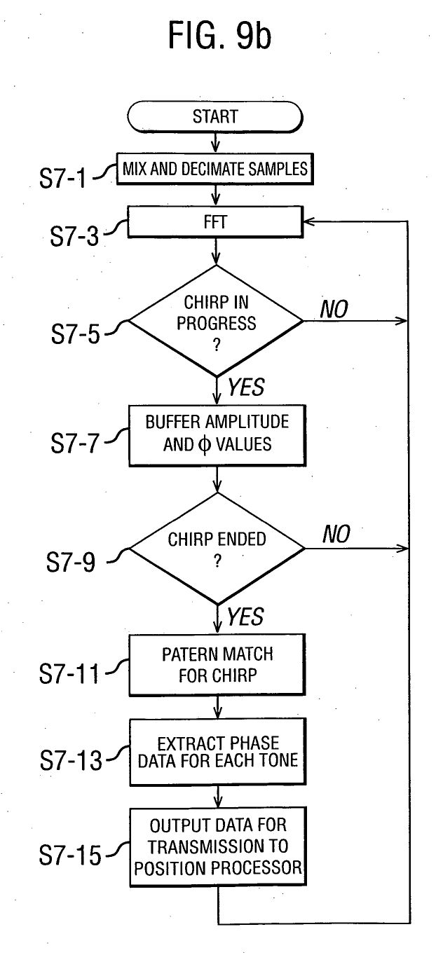

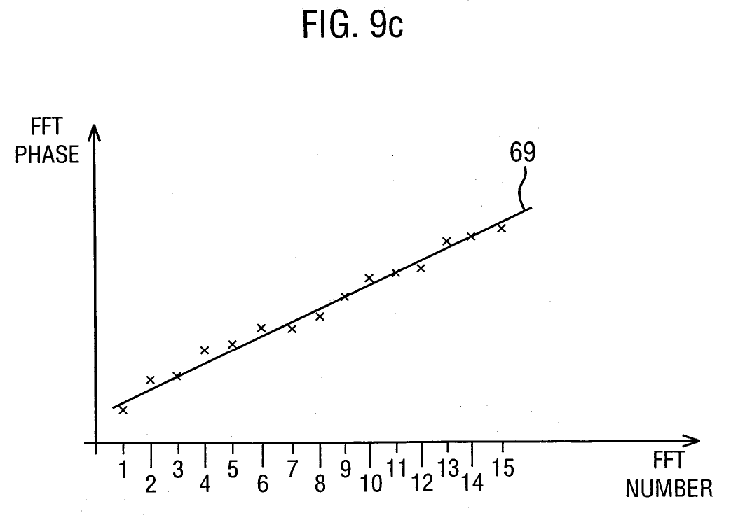

FIG. 9a is a block diagram showing the functional elements of a digital signal processor block which forms part of the receiver shown in FIG. 5;

FIG. 9b is a flow chart illustrating the main processing steps performed by the digital signal processor of the receiver shown in FIG. 5;

FIG. 9c is a graphical representation of the different FFT results obtained for each tone of each chirp received by the receiver;

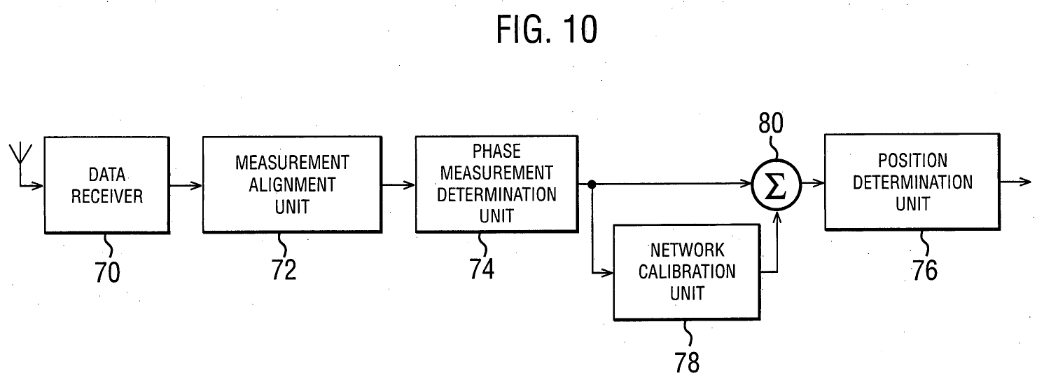

FIG. 10 is a block diagram showing the functional elements of the position processor used in the second example to determine the current position of the moveable object;

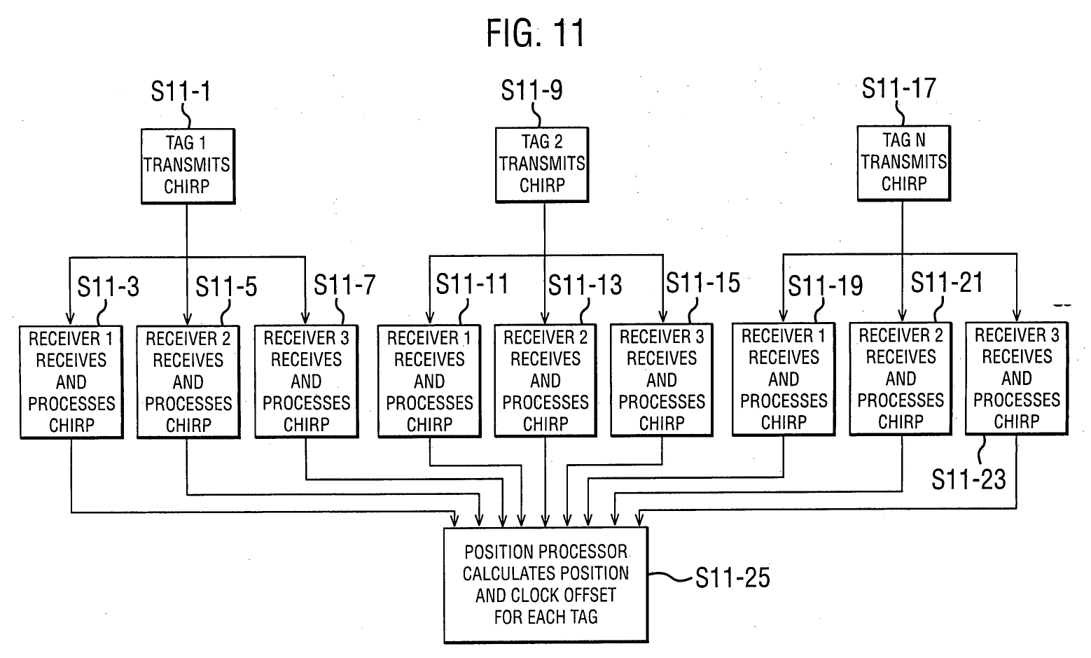

FIG. 11 is a flow chart showing the main operational steps performed by the elements of the tracking system in a third example;

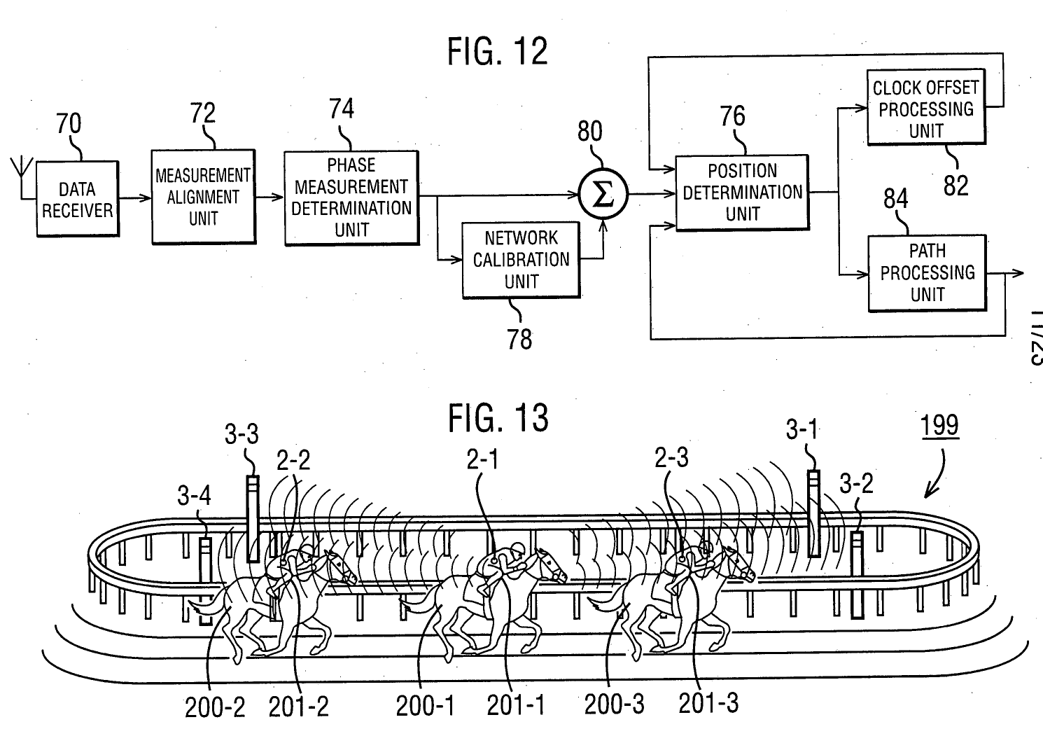

FIG. 12 is a block diagram showing the functional elements of the position processor of the third example;

FIG. 13 shows a conceptual arrangement of a number of receivers around a horse-racing track to receive locator chirps transmitted by the mobile tags carried by each horse;

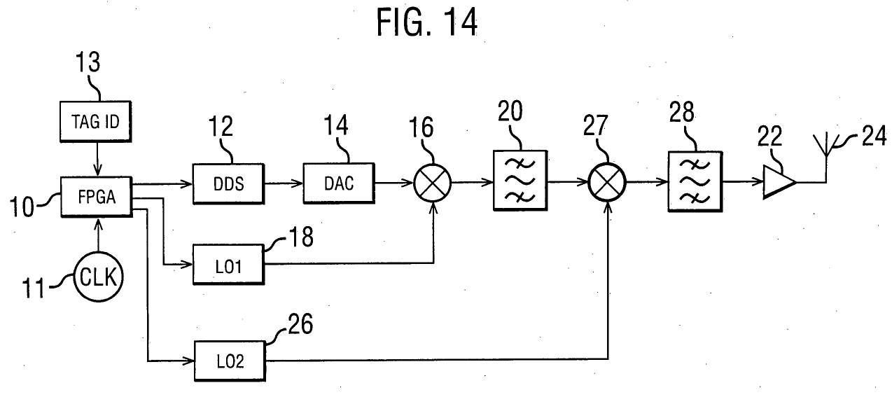

FIG. 14 is a block diagram showing the functional elements of a tag transmitter used in a fourth example;

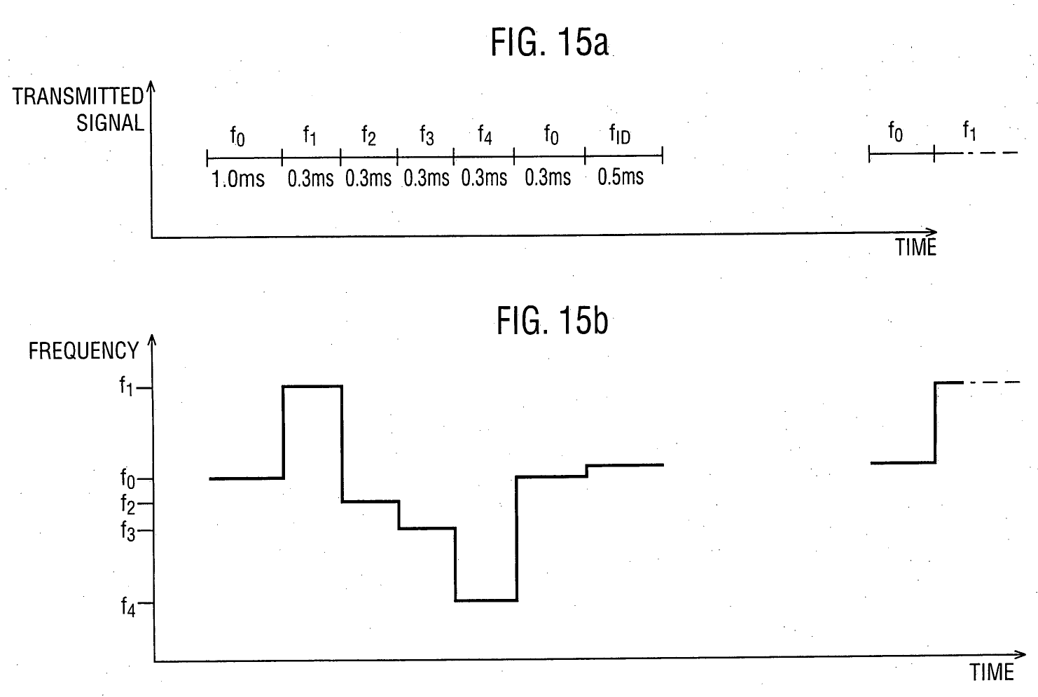

FIGS. 15a and 15b are time plots illustrating the form of signal transmitted by the tag transmitter shown in FIG. 13;

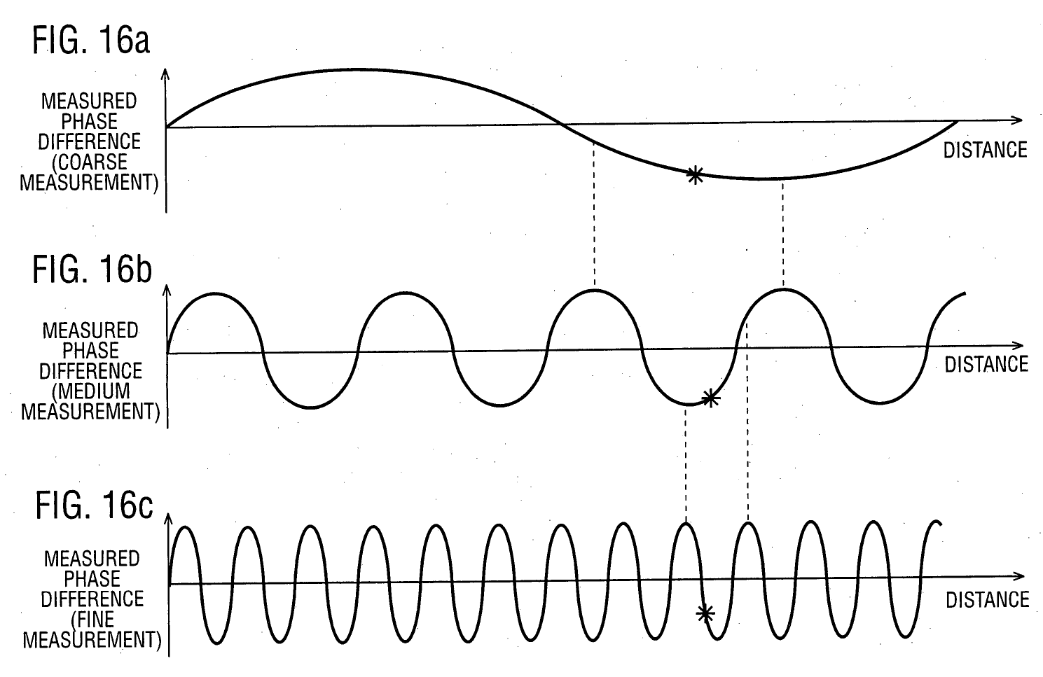

FIGS. 16a, 16b and 16c are time plots illustrating the use of the relative wavelengths of the frequency differences to determine the coarse, medium and fine position estimates;

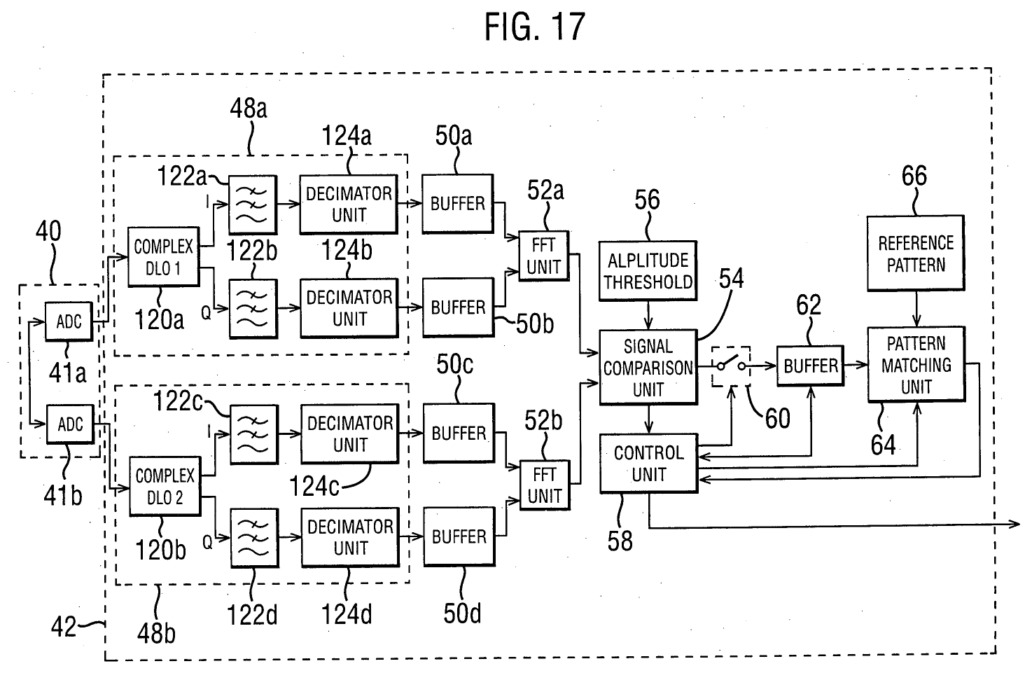

FIG. 17 is a block diagram showing the functional elements of a digital signal processor which forms part of the receiver of the fourth example;

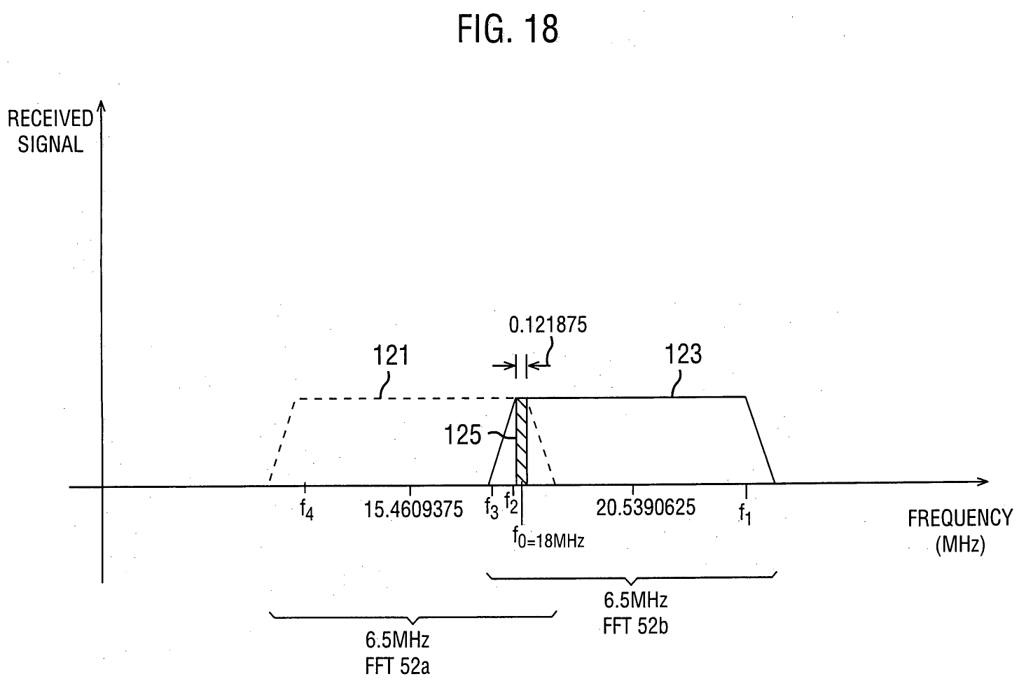

FIG. 18 is a frequency plot illustrating two parts of the received signal's spectrum that are processed by respective processing channels which form part of the digital signal processor shown in FIG. 17;

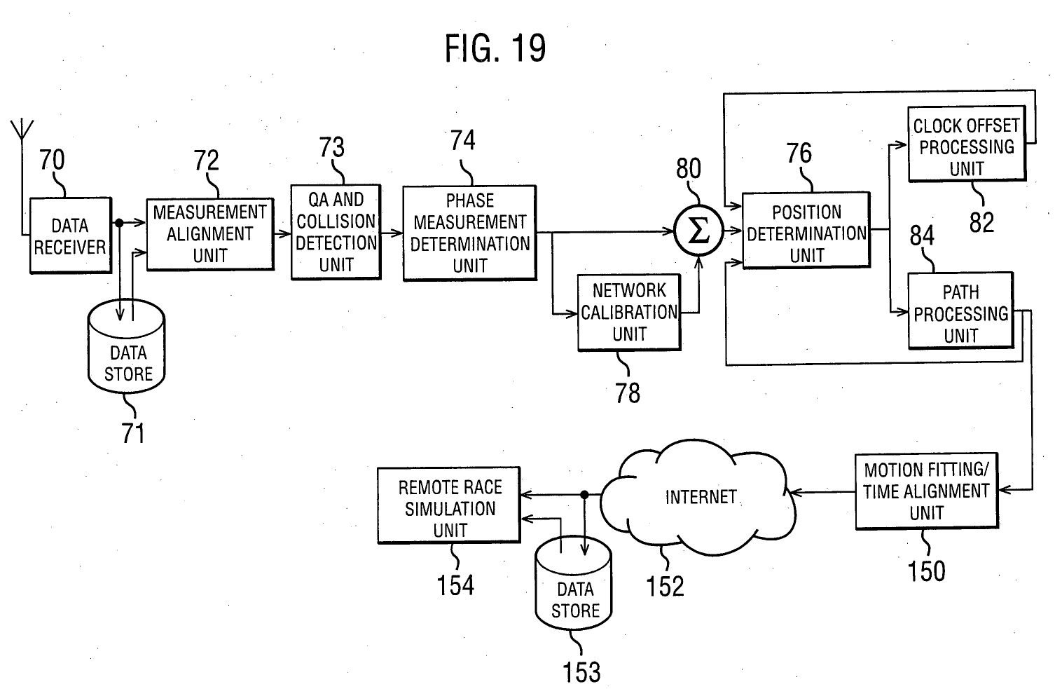

FIG. 19 is a block diagram showing the functional elements of the position processor of the fourth example;

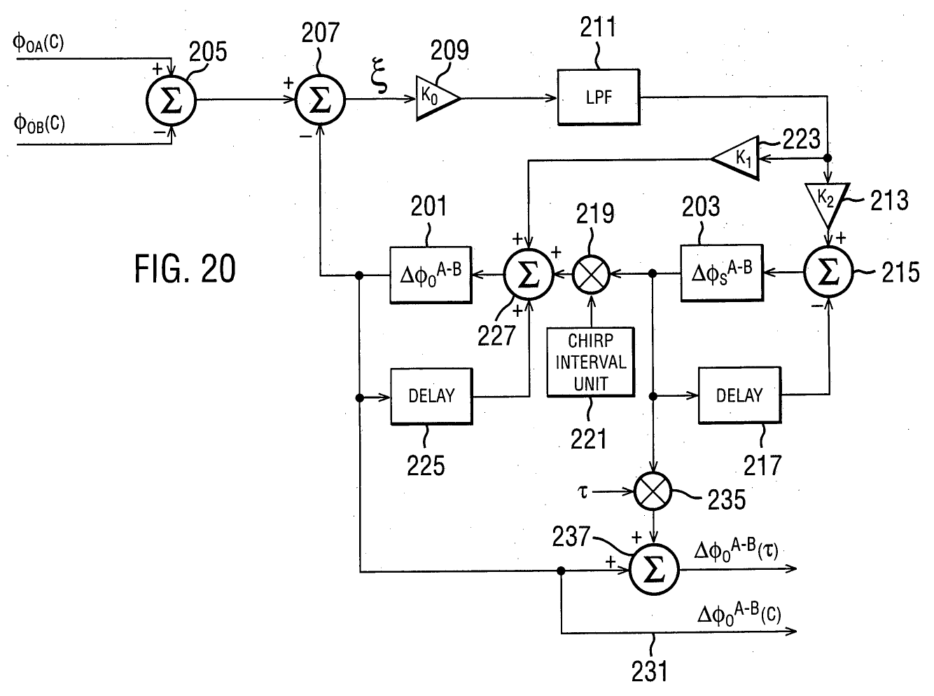

FIG. 20 is a block diagram showing the functional elements of a phase difference tracking loop for tracking the difference in phase in the position processor of the fourth example;

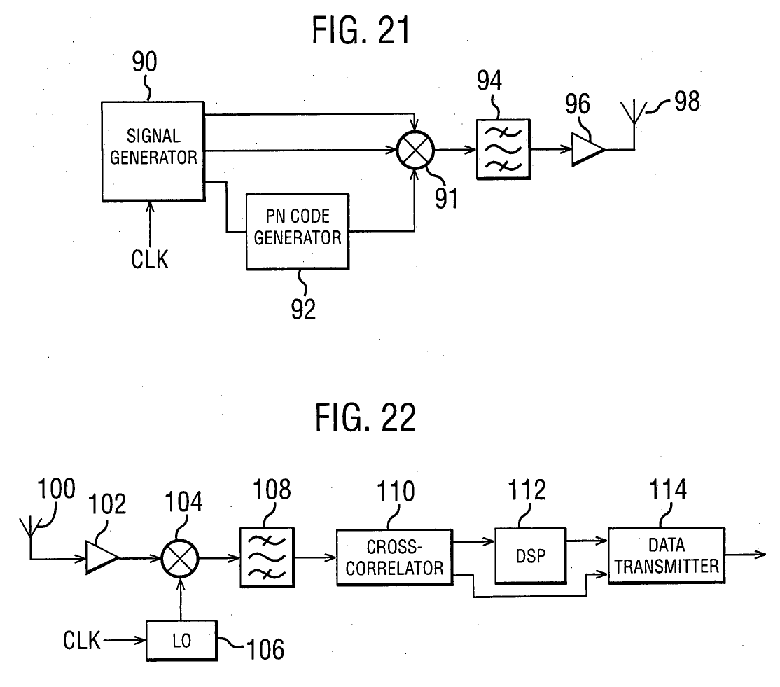

FIG. 21 is a block diagram showing the functional elements of a tag transmitter used in a sixth example;

FIG. 22 is a block diagram showing the functional elements of a receiver used in the sixth example;

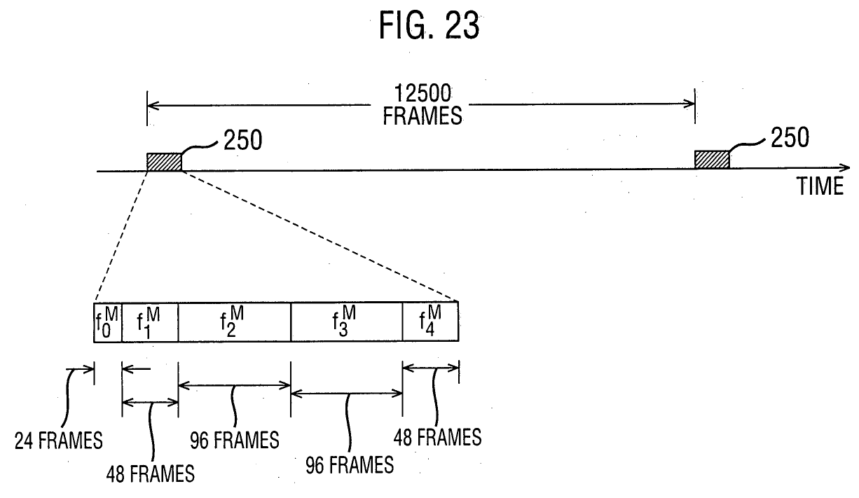

FIG. 23 is a time plot illustrating the form of a transmission signal generated by a mobile tag used in an embodiment of the invention;

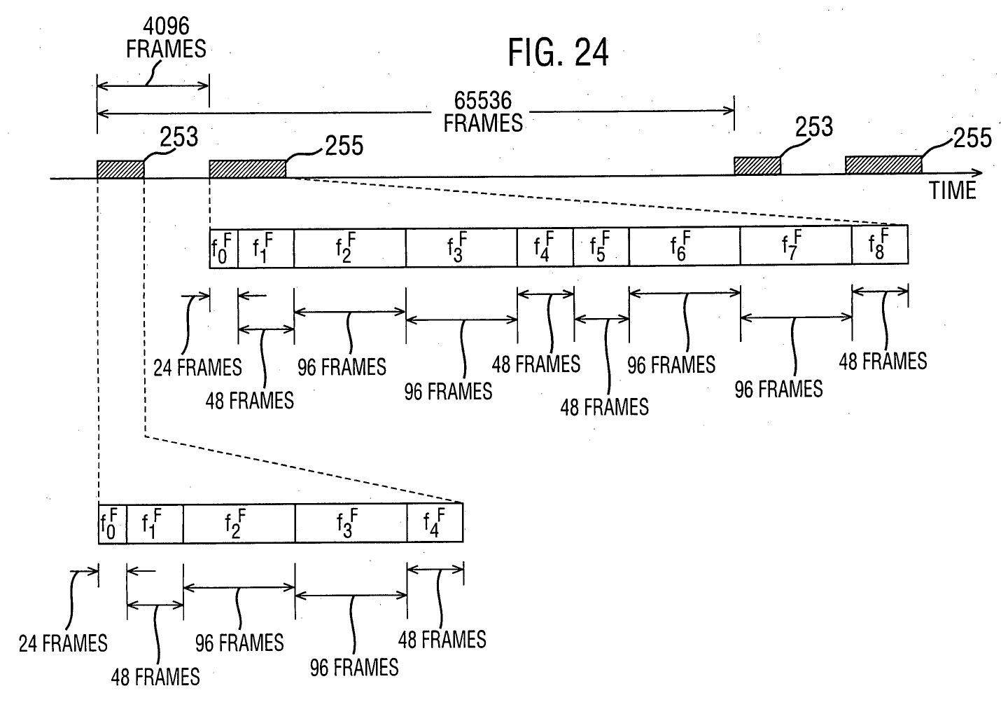

FIG. 24 is a time plot illustrating the form of a transmission signal generated by a fixed tag used in an embodiment of the invention;

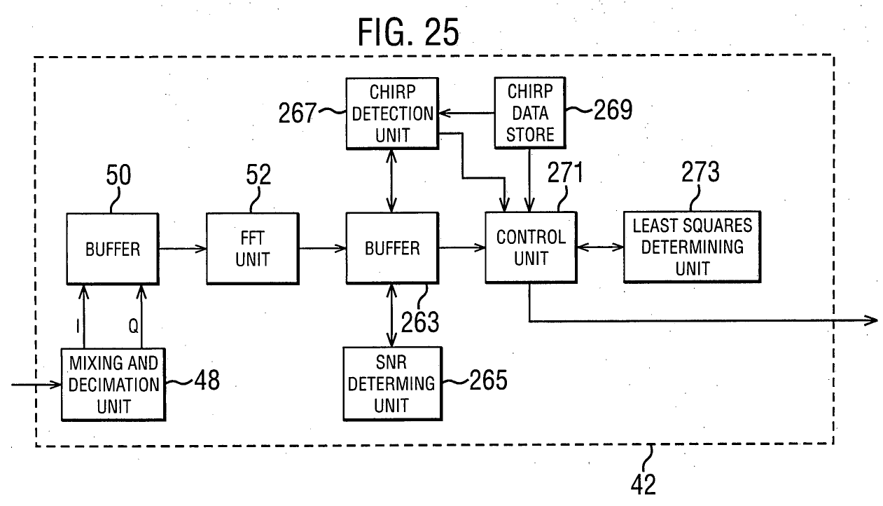

FIG. 25 is a block diagram showing the functional elements of a digital signal processor block which forms part of a receiver used in an embodiment of the invention;

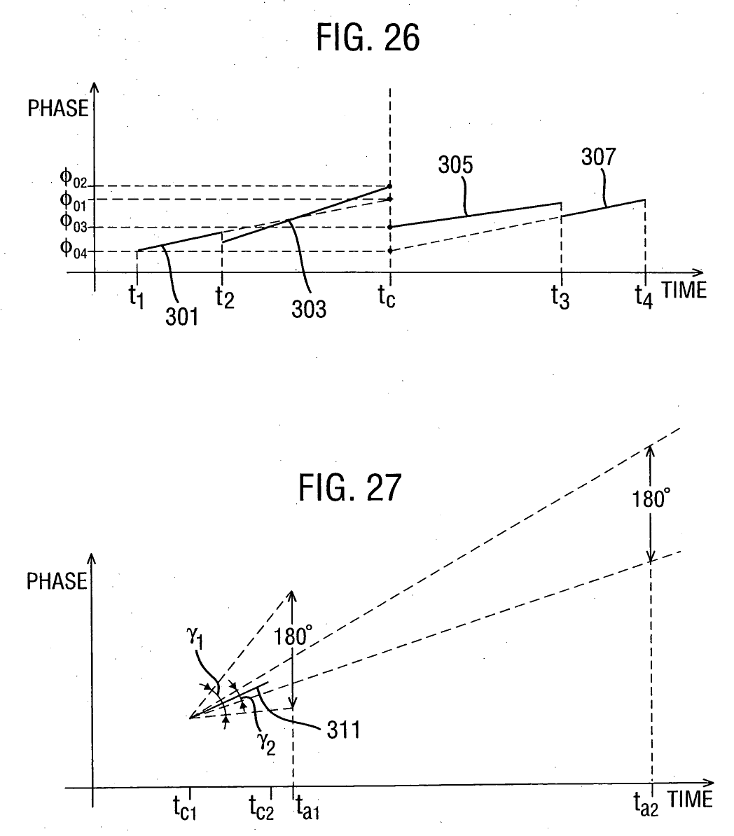

FIG. 26 is a phase plot illustrating the way in which the phase of four tones within a received signal varies with time; and FIG. 27 is a phase plot illustrating the way in which the phase of a tone transmitted by a fixed tag varies with time between successive transmission chirps.

### FIRST EXAMPLE

Overview

FIG. 1 illustrates the tracking environment 1 in which the tracking system of the present example operates. The tracking system is used in this example for tracking the position of a mobile tag 2 which is attached to a jockey on a horse (not shown) which is to be tracked. The mobile tag 2 carried by the jockey transmits a signal which is received, in this example, by three fixed receivers 3-1, 3-2 and 3-3. The receivers 3 process the received signals and transmit the processed signals to a position processor 4 which then calculates the position of the mobile tag 2 from the signals received from the receivers 3. In this example, the mobile tag 2 transmits two tones (tone A and tone B) of different frequency which enables the system to be able to determine the absolute position of the mobile tag over a relatively large operating range whilst maintaining position sensing accuracy. The reason for this will now be described with reference to FIG. 2.

When a single tone is transmitted between the tag 2 and a receiver 3, in order to be able to determine absolute position from a measurement of the phase of the received signal, the distance between the tag 2 and the receiver 3 must be less than the wavelength of the transmitted tone. If this is not the case, then a phase ambiguity problem arises. As discussed above in the introduction, for an application such as horse racing, this may require a transmission frequency in the kilohertz or megahertz part of the radio spectrum. However, when two tones of different frequencies are transmitted, it is the difference between the frequencies which sets the maximum possible unambiguous range of measurement. This is because, as illustrated in FIG. 2, the instantaneous phase relationship between the two tones (tone A and tone B) changes in each wavelength and repeats at a frequency given by the difference between the frequencies of the two tones. Therefore, with a two tone system, the maximum unambiguous range of measurement is given by the following equation:

$$MAX RANGE = \frac{c}{{f}_{A} - {f}_{B}} \qquad ( 1 )$$

where c is the speed of light, f_{A} is the frequency of tone A and f_{B} is the frequency of tone B. In other words, the maximum range is not dependent on the actual frequency of the transmitted signals but only on their difference in frequency. Therefore, frequencies from parts of the radio spectrum which are not regulated can be used. For example, two tones separated by 1 MHz could be transmitted within the 2.4 to 2.485 GHz bandwidth which is allocated for use without a licence in accordance with IEEE Standard 802.11. Such a system would be able to provide absolute position measurement over a range of approximately 300 metres (whereas a single tone at such a frequency would provide an unambiguous range of measurement of about 10 cm).
Mobile Tag

A description will now be given with reference to FIGS. 3 and 4 of the functional elements of the mobile tag 2 used in the first example. As shown, the tag 2 has a Field Programable Gate Array (FPGA) 10 which receives a clock input from a crystal oscillator (CLK) 11. The FPGA 10 outputs data identifying the frequency, the starting phase and the duration of a signal to be synthesised to a Direct Digital Synthesizer (DDS) 12. In response, the DDS 12 generates the tone at the desired frequency starting from the described start phase and for the desired duration. In this example, the FPGA 10 is programmed to cause the DDS 12 to generate a first frequency, followed by a second frequency, followed by a pause, followed once again by the first frequency then the second frequency and again a pause in a constantly repeating pattern. In this example, the DDS 12 does not directly generate gigahertz signals. Instead, it generates intermediate frequencies in the range of 70 MHz to enable the use of simpler components therein. The digital signal output by the DDS 12 is then converted into an analogue signal by the digital-to-analogue converter (DAC) 14. This signal is then up-converted to the appropriate transmission frequency (2.410 GHz for tone A and 2.409 GHz for tone B in this example) by mixing it in a mixer 16 with an appropriate mixing signal generated by the local oscillator 18. In this example, the local oscillator 18 is programmable and generates a mixing frequency as defined by a signal received from the FPGA 10. The mixed signal is then filtered by a filter 20 to remove unwanted components from the mixing operation and then the filtered signal is amplified by a power amplifier 22 and transmitted (broadcast) via the antenna 24.

FIG. 4 illustrates the form of the two tone signal transmitted by the mobile tag 2 in this example. As can be seen from FIG. 4, the two tones (tone A and tone B) have different frequencies (not shown to scale), with tone A being transmitted first then tone B followed by no tone, followed by tone A again, tone B, no tone and so on. Each pulse sequence of tone A followed by tone B transmitted by the mobile tag 2 will be referred to hereinafter as a chirp. In this example, the duration of each tone pulse is approximately 300 μs giving a total chirp duration of approximately 600 μs and the chirp repetition interval is approximately 100 ms.

The dashed lines shown in FIG. 4 illustrate that when a tone starts to be transmitted after a pause, the phase of the tone at that time is the same as it would have been had the tone been continuously transmitted since the last pulse. The start phase of each pulse is determined by the FPGA 10 from the start phase of the previous tone, the frequency of the tone and the time elapsed since the beginning of the last pulse. In this example, the repetition rate is chosen to ensure that each chirp starts from the zero phase point of a basic reference frequency derived from the clock oscillator 11.

Since this example determines the position of the mobile tag 2 by considering the phase of a signal transmitted by the tag, it is important to consider the source of the signal generated by the tag, its phase and any phase shifts added by the components in the tag. The fundamental signal source in the tag is the crystal oscillator 11 used to generate the system clock (CLK) which operates at some predetermined frequency (f_{clk}) and which has some initial phase (φ_{clk}(t)). Although not shown in FIG. 3, the DDS 12 generates its output using this clock signal. It does this by, effectively, frequency multiplying the clock signal to generate the appropriate intermediate frequency signals which it outputs to the digital-to-analogue converter 14.

Therefore, the phase of the signal output from the DDS 12 when tone A is transmitted can be represented by: DDS
φ_{A}^{DDS}=N_{A}φ_{clk}(t) (2)
and the phase of the signal output by the DDS 12 when tone B is transmitted can be represented by:
φ_{B}^{DDS=}N_{B}φ_{clk}(t) (3)
where N_{A} and N_{B} represent the effective multiple of the clock frequency for tone A and tone B respectively. The local oscillator 18 operates in a similar manner so that the phase of the mixing signal can be represented by:
φ_{LO}=Kφ_{clk}(t) (4)
where K represents the effective multiple of the clock frequency for the mixing signal. The other components of the tag (i.e. the DAC 14, the mixer 16, the filter 20, the power amplifier 22 and the antenna 24) each introduce a phase delay. However, in this example, it is assumed that these phase delays are the same for each of the tones and therefore the phase (φ_{A}) of the transmitted signal for tone A can be represented by:
φ_{A}=N_{A}φ_{clk}(t)+Kφ_{clk}(t)+φ_{c} (5)
and the phase (φ_{B}) of the transmitted signal for tone B can be represented by:
φ_{B}=N_{B}φ_{clk}(t)+Kφ_{clk}(t)+φ_{c} (6)
where φ_{c} is the constant phase delay added by the DAC 14, the mixer 16, the filter 20, the power amplifier 22 and the antenna 24.
Receiver

The receivers 3-1, 3-2 and 3-3 used in this example are functionally the same and a description of the functional elements of one of the receivers 3 will now be given with reference to FIGS. 5, 6 and 7.

As shown in FIG. 5, the signal is received by the receive antenna 30 and is passed to a low noise amplifier 32 where the received signal is amplified. The amplified signal is then passed to a mixer 34 where it is mixed with a signal generated by local oscillator 36 to down-convert the received signal from the transmitted gigahertz frequency to the intermediate frequency at approximately 70 MHz. As shown, the local oscillator 36 generates the mixing signal from a local clock signal which is generated from a crystal oscillator (CLK) 37 which is the same as the oscillator 11 used in the mobile tag 2. The output from the mixer 34 is then filtered by a bandpass filter 38 to remove unwanted frequency components from the mixed signal and is then passed to an analogue-to-digital converter 40 which converts the down-converted signals into digital signals. The digital samples output by the ADC 40 are then input to a digital signal processor (DSP) 42 which processes the samples to generate data that varies with the phase of the received signal.

The signal received by the receiver 3 will correspond to the signal transmitted by the mobile tag 2, however the passage of the signal through the air introduces a further phase delay proportional to the distance the signal has travelled. The received signal phase for tone A and tone B at receiver R can therefore be represented by:
φ_{A}^{R}=N_{A}φ_{clk}(t)+K φ_{clk}(t)+φ_{c}+φ_{dA}^{R}(t) (7)
and
φ_{B}^{R}=N_{B}φ_{clk}(t)+Kφ_{clk}(t)+φ_{c}+φ_{dB}^{R}(t) (8)

In this example, it is assumed that the crystal oscillators in the receivers 3 and the mobile tag 2 are perfectly synchronised with each other. Therefore, the terms of the received phase involving φ_{clk}(t) can be ignored. Further, as with the similar components of the mobile tag 2, the receive antenna 30, the low noise amplifier 32, the mixer 34, the filter 38, the analogue-to-digital converter 40 and the digital signal processor 42 will introduce a phase delay into the received phase.

However, in this example it is assumed that these phase delays are constant for a given chirp and can be incorporated within the expression for φ_{c}.

The phase data generated by the DSP 42 is then passed, together with a time stamp for the measurement and a receiver ID, to a data transmitter 44 which, in this example, packages the data using a suitable network protocol (such as TCP/IP) and transmits the data to the position processor 4 over an appropriate data network. In the present example, the link between the receivers 3 and the position processor 4 is made using a wireless network. That is a conventional computer network system implemented without wires but using radio transmitters. Examples of such a wireless network include AirPort™ and Wi-Fi™ systems.

Position Processor

Referring now to FIG. 6, the position processor 4 used in this example will now be described in detail. The data transmitted to the position processor from all of the receivers 3 is received by data receiver 70 which extracts the phase data from the network packaging and control data that was added for transmission purposes. The extracted phase data is then passed to a measurement alignment unit 72 which processes the received phase data to group the phase data for the same chirp from all of the receivers into a separate cluster. This is required since data transmitted over a TCP/IP network may not arrive at the receiver in the order that it was transmitted. The measurement alignment unit 72 does this using the transmitted time stamp data and by waiting until the data from all of the receivers for a given chirp should have been received, allowing for the network latency.

The aligned measurements for a current chirp are then passed to a phase measurement determination unit 74 which performs a subtraction operation to subtract the phase measurements associated with the tone B signal from the phase measurements associated with the tone A signal.

In particular, the phase measurement determination unit 74 subtracts the phase measurement from receiver 1 for tone B from the phase measurement from receiver 1 for tone A, to generate a phase difference measurement for receiver 1. The phase measurement determination unit 74 also does this for the phase measurements received from the other receivers. In this example, there are three receivers 3-1, 3-2 and 3-3 which receive the tone A and tone B signals transmitted by the mobile tag 2.

Therefore, the phase measurement determination unit 74 will generate the following three phase difference signals, for each chirp transmitted from the tag, which are passed to the position determination unit 76.
Δφ¹(t)=φ_{dA}¹(t)−φ_{dB}¹(t)=d₁(t)[f_{A}−f_{B}]/c
Δφ²(t)=φ_{dA}²(t)−φ_{dB}²(t)=d₂(t)[f_{A}−f_{B}]/c
Δφ³(t)=φ_{dA}³(t)−φ_{dB}³(t)=d₃(t)[f_{A-f}_{B}]/c (9)
where d₁(t) is the distance between the mobile tag 2 and receiver 3-1 at time t; d₂(t) is the distance between the mobile tag 2 and the receiver 3-2 at time t; d₃(t) is the distance between the mobile tag 2 and the receiver 3-3 at time t; f_{A} is the frequency of the transmitted tone A; and f_{B} is the frequency of the transmitted tone B. As can be seen from equation (9), by taking the phase difference of the phase measurements from each receiver, the common phase delay (φ_{c}) introduced by the electronic components of the mobile tag 2 and the receivers 3 has been removed from the calculation.

The position determination unit 76 uses the three phase difference measurements obtained from the phase measurement determination unit 74 (together with the known transmission frequencies of the mobile tag 2) to generate a value for the distance between the mobile tag 2 and each of the receivers 3. From these distances, it determines the position of the mobile tag relative to the known position of the receivers 3. This position measurement will be an absolute measurement, provided the mobile tag 2 is within one wavelength of the beat frequency (f_{A}−f_{B}) of the transmitted tones. The way in which these calculations are done is well known to those skilled in the art and will not be described further here.

### SECOND EXAMPLE

In the first example, it was assumed that the clocks in the tag and in the receivers 3 were synchronised to one another. Whilst this is possible to achieve, it is impractical for most applications. A second example will now be described in which the tag and the receivers are not synchronised. In this example, the mobile tag 2 has the same general architecture as the mobile tag 2 used in the first example. In this example, a network calibration technique is used to account for the lack of synchronisation between the receivers 3. This calibration technique uses signals transmitted from a fixed tag 5 whose position is known and which is constructed and operates in the same way as the mobile tag 2.

In this example, the processing carried out by the digital signal processor 42 in each receiver 3 is different to the processing carried out in the DSP 42 used in the first example. A more detailed description will now be given of the operation of the ADC 40 and of the DSP 42 used in this example with reference to FIGS. 8 and 9. In this example, the receivers 3 are arranged to digitise a frequency band of 11 MHz which is centred around the 70 MHz intermediate frequency. It does this using sub-sampling techniques by sampling the down-converted signal at 52 MHz. Sub-sampling this frequency band at this rate results in a digitised version of this 11 MHz band centred at 18 MHz. This is illustrated in FIG. 8 which shows the 11 MHz band 41 which is centred at 70 MHz and the corresponding sub-sampled 11 MHz band 43 which is centred at 18 MHz. As shown in FIG. 8, this sub-sampled frequency band 43 lies entirely within the Nyquist band represented by the dashed box 45. The techniques of sub-sampling are well known and will not be described further.

As shown in FIG. 9a, the samples generated by the analogue-to-digital converter 40 are input to a digital mixing and decimation unit 48 in the DSP 42, where the digitised frequency band 43 is mixed to baseband to generate in phase (I) and quadrature phase (Q) samples which are then decimated by four (step S7-1 in FIG. 9b). The resulting 13 mega I and Q samples per second are stored in a buffer 50. Blocks of these samples are then passed one block at a time to a Fast Fourier Transform (FFT) unit 52 which performs a complex FFT (step S7-3) using both the in phase (I) and quadrature phase (Q) signals in the block. In this example, the FFT takes a 256 point FFT on blocks of 256 I and 256 Q samples. With the above sampling rate, this means that the FFT unit 52 produces an FFT output (which takes the form of an array of amplitude and phase values for a number of different frequencies for each block of input samples) at a rate of one every 19.7 μs.

When the mobile tag 2 transmits a pulse either of tone A or tone B, the output from the FFT unit 52 should include an amplitude value and a phase value for that tone. Since the mobile tag 2 transmits pulses of approximately 300 μs of each tone, this means that there should be 15 (300/19.7) consecutive FFT outputs having an amplitude and phase value which corresponds to the transmitted tone. The FFT calculated for each block of samples is input to a signal comparison unit 54 which determines whether or not the current FFT might form part of a chirp (step S7-5). It does this by comparing the amplitude values in the received FFT with an amplitude threshold stored in the store 56. The result of this comparison is passed to a control unit 58 which controls the position of a switch 60 so that if any of the amplitude values in the current FFT are above the threshold, then those amplitude values and the corresponding phase values are stored (step S7-7) together with an indication of the frequencies with which those amplitude values are associated and with a time stamp identifying the current FFT. These amplitude and phase values will continue to be stored in the buffer 62 until the signal comparison unit 54 and the control unit 58 identify (what they think is) the end of the chirp (step S7-9) by detecting when the amplitude values fall below the amplitude threshold 56.

As those skilled in the art will appreciate, whilst the use of the comparison unit and the amplitude threshold avoids the processing of general background noise, sometimes the background noise at particular frequencies will be above the threshold and will cause the corresponding FFT values to be stored in the buffer 62.

Therefore, in this example, the data values stored in the buffer 62 are passed to a pattern matcher 64 which looks for patterns in the data stored in the buffer 62 which are characteristic of a chirp produced by the mobile tag 2. In particular, as mentioned above, the mobile tag 2 outputs a chirp comprising approximately 300 ps of tone A followed by approximately 300 ps of tone B. Therefore, the FFT data corresponding to a chirp should include an amplitude and phase value corresponding to tone A in fifteen consecutive FFT outputs followed by an amplitude and phase value corresponding to tone B in fifteen consecutive FFT outputs. This expected pattern is stored in the reference pattern store 66 and the pattern matching unit 64 compares the data stored in the buffer 62 with this reference pattern in order to determine whether or not the data actually corresponds to a chirp. By performing this pattern matching operation, the receiver reduces further the risk of outputting erroneous position information.

When the pattern matching unit 64 identifies that the data stored in the buffer 62 corresponds to a chirp, it determines a time stamp for the chirp from a receiver clock and determines the optimum timeslots for the presence of each tone. In this example, the receiver clock is a simple sample counter which is incremented by one for each block of 256 samples received. This information is then passed to the control unit 58 which then extracts phase information for both tone A and tone B from the identified values stored in the buffer 62 and outputs (step S7-15) this phase information from the DSP 42 to the data transmitter 44. In this example, the control unit 58 outputs a single set of phase measurements for each of tone A and tone B for each chirp. However, as mentioned above, the buffer 62 will hold fifteen consecutive FFT outputs having amplitude and phase values which correspond to each transmitted tone. If the clock frequencies of the tag 2 and the receiver 3 are perfectly synchronised and chosen so that each of the tones is centred within the corresponding FFT frequency bin, then the fifteen FFT phase values for each of the transmitted tones will remain constant. However, since the clock frequencies are not synchronised in this example, the phase terms for these fifteen FFT outputs will be different. Fortunately, during a single chirp, it is unlikely that the synchronisation between the mobile tag 2 and the receiver 3 will change and therefore the change in the phase values between successive FFT outputs should be approximately the same. This is illustrated in FIG. 9c which shows the fifteen phase values obtained from fifteen consecutive FFT outputs and the line 69 which best fits these points, the gradient of which depends upon the lack of synchronisation between the transmitter and receiver clocks.

Consequently, in this example, the control unit 58 determines the gradient of the best fit line 69 (using a least squares regression algorithm) and outputs this slope measurement (referred to hereinafter as the phase slope measurement φₛ) together with the phase value measured from the best fit line 69 at a position corresponding to one of the fifteen FFT outputs (referred to hereinafter as the phase offset measurement φ₀). It does not matter which one of the phase values is used as the phase offset measurement. However, in order to avoid possible problems with phase offset measurements at the beginning and the end of the pulse, in this example, the control unit outputs the phase offset measurement (φ₀) of the best fit line 69 corresponding to the eighth FFT (i.e. the FFT obtained in the middle of the tone pulse). In this example, the frequency of the two tones A and B have been chosen so that they will both appear at approximately the same position within the corresponding FFT frequency bin relative to the centre of that bin. As a result, the phase slope measurement for tone A and the phase slope measurement for tone B should be approximately the same. However, in this example, separate phase slope measurements (φ_{sA} and φ_{sB}) are taken and used to detect for corruption of the chirp data. These two phase measurements are then output to the data transmitter 44 together with the time stamp for that chirp and the receiver ID.

In addition to receiving the chirps from the mobile tag 2, the receivers 3 also receive chirps from the fixed tag 5. The receivers process these chirps in the same way to generate corresponding phase measurements for the signals received from the fixed tag 5. As will be described below, the phase measurements obtained from the fixed tag 5 are used to correct for the lack of synchronisation of the receivers 3.

Referring now to FIG. 10, the position processor 4 of the second example will now be described in more detail. In the position processor 4, the data receiver 70 and measurement alignment unit 72 operate in the same way as described above with reference to FIG. 6 in the first example. The purpose of the phase measurement determination unit 74 is to subtract the phase offset measurement for tone B of a given chirp received at a given receiver from the phase offset measurement for tone A for the same chirp received at the same receiver. However, as noted above, there is a constant drift in the measured phase caused by the lack of synchronisation between the mobile tag clock and the receiver clock (measured as the phase slope measurement (φₛ) and as there are 15 FFT operations between the phase offset measurement (φ_{oA}) for tone A and the phase offset measurement (φ_{oB}) for tone B, the phase measurement determination unit 74 must add in a correction based on the phase slope measurements φ_{sA} and φ_{sB} in order to extrapolate these measurements to a common time. In this example, the phase offset measurements are extrapolated to a point in time midway between the times of the two tones being subtracted. To do this, the determination unit 74 multiplies the phase slope measurement for tone A (φ_{sA}) by 7.5 (since normalised units of time are used to determine the phase slope measurement φₛ rather than seconds) and then adds this to the phase offset measurement for tone A (φ_{oA}). The determination unit 74 also multiplies the phase slope measurement for tone B (φ_{sB}) by 7.5 and then subtracts this from the phase offset value measured for tone B (φ_{oB}). Thus the sum performed by the phase measurement determination unit 74 is as follows:
Δφ_{TR}(t=C)=φ_{oA}^{TR}(t=C)+7.5φ_{sA}^{TR}(t=C)−[φ_{oB}^{TR}(t=C)−7.5φ_{sB}^{TR}(t=C)] (10)
which in this example gives the phase difference measure for tag T from the signals received at receiver R at the time corresponding to the middle of the chirp (i.e. at t=C). As in the first example, the phase difference calculated is equivalent to subtracting equation (8) from equation (7) but this time not ignoring the φ_{clk}(t) terms as follows:
Δφ_{TR}(C)=(N_{A}−N_{B})φ_{clk}^{TR}(C)+φ_{dA}^{TR}(C)−_{dB}^{TR}(C) (11)
where φclk^{TR}(C) is the difference between the clock phase of the tag (T) and the clock phase of the receiver (R) at the time corresponding to the middle of the chirp (ie φ_{clk}^{tag}(C)−φ_{clk}^{R}(C)). As before, the constant phase lag φ_{c} has been cancelled together with the common term involving the up-converter multiple K.

In this example, the phase difference measurements obtained from chirps transmitted by the mobile tag 2 are output directly to the adder 80 and the phase difference measurements obtained from chirps transmitted by the fixed tag 5 are output to a network calibration unit 78 which calculates correction values to be added to the phase difference measurements obtained from chirps transmitted by the mobile tag 2 in the adder 80. The phase difference measurements obtained for the mobile tag 2 vary with the phase difference between the clock frequency of the tag 2 and the clock frequency of the receiver from which the measurement is derived. In this example the calibration unit 78 calculates correction values to be added to these phase difference measurements in order to effectively reference the measurements from all of the receivers 3 back to a single clock—that of the fixed tag 5, thereby removing their dependance on the different phases of the receiver clocks. It does this by adding the following correction value:

$$Correction value ( R ) = - ( {N}_{A} - {N}_{B} ) {ϕ}_{clk}^{fxdR} ( t = C ) \qquad ( 12 )$$

where φ_{clk}^{fxdR}(c) represents the difference in the phase of the fixed tag 5 relative to the phase of the receiver R at the time corresponding to the middle of the chirp transmitted by the mobile tag 2 (ie φ_{clk}^{fxd}(t=C)−φ_{clk}^{R} (t=C)). Since the position of the fixed tag is known, the value of φ_{clk}^{fxdR} at the time corresponding to when the fixed tag transmits its chirp can be determined.

However, since there is likely to be a frequency offset between the frequency of the clock in the fixed tag and the frequency of the clock in the receiver, this phase difference will have changed by the time that the chirp from the mobile tag is received. Therefore, in this example, the network calibration unit 78 monitors the way in which φ_{clk}^{fxdR} changes with time by monitoring how these value changes over a number of chirps transmitted by the fixed tag 5. It then uses this history of information to determine what φ_{clk}^{fxdR} will be at the time of the chirp from the mobile tag. It then uses this value to work out the appropriate correction value using equation (12) above.

Thus, when a phase difference value for a chirp transmitted by the mobile tag 2 and received by receiver 3-1 is output by the phase measurement subtraction unit 74, calibration unit 78 outputs the specific correction value for that chirp and for receiver 3-1, to the adder 80 where it is added to the phase difference measurement from the determination unit 74.

Adding the appropriate correction value to equation 11 gives the following corrected phase difference measurement:

$$\begin{matrix}{Δϕ}_{TR}^{corr} ( C ) = {ϕ}_{oA}^{TR} ( C ) - {ϕ}_{oB}^{TR} ( C ) + 15 {ϕ}_{s}^{TR} ( C ) - \\ ( {N}_{A} - {N}_{B} ) {ϕ}_{clk}^{fxdR} ( C ) \\ = ( {N}_{A} - {N}_{B} ) [ {ϕ}_{clk}^{mob} ( C ) - {ϕ}_{clk}^{fxd} ( C ) ] + {ϕ}_{dA}^{TR} ( C ) - {ϕ}_{d B}^{TR} ( C )\end{matrix} \qquad ( 13 )$$

As can be seen from equation 13, the corrected phase difference values are no longer dependent on the phase of the receiver clocks. Instead they are all referenced back to the clock phase of the fixed tag (i.e. φ_{clk}^{fxd}(C)). These corrected phase difference measurements are then passed to the position determination unit 76 and used to solve equation 13 to find the position of the mobile tag 2 and to determine the phase of the mobile tag's clock relative to that of the fixed tag 5 (at the time of the current chirp being processed). In this example, the position determination unit 76 uses an iterative numerical reduction method to solve for these unknowns from these corrected phase difference measurements. The way that it does this will now be described in more detail. In order to illustrate the calculations that are performed by the position determination unit 76, it is necessary to expand equation 13 to introduce the distance between the mobile tag 2 and the respective receivers 3.

The relationship between (φ_{dA}^{TR}(C)−φ_{dB}^{TR}(C)) is given in equation 9 which can be expanded further in terms of the clock frequency of the tag 2 to give:
φ_{dB}^{TR}(C)−φ_{dA}^{TR}(C)=(N_{A}−N_{B})f_{clk}d_{TR}(C)/c (14)
Where f_{clk} is the frequency of the clock 11 of the mobile tag 2. Substituting this into equation 13 gives:
Δφ_{TR}^{COIT}(C)=(N_{A}−N_{B})[φ_{Tf}(C)+f_{clk}d_{TR}(C)/c] (15)
where φ_{Tf}(C) is the phase of the mobile tag clock relative to that of the fixed tag clock at the time of the current chirp (C). The unknowns in this equation are φ_{Tf}(C) and d_{TR}(C). Since there are three receivers, there will be three equations involving the four unknowns φ_{Tf}(C), d_{T1}(C), d_{T2}(C) and d_{T3}(t). However, as the positions of the receivers 3 are all known, the three distance measures can be re-referenced relative to a common origin and written in terms of a two dimensional position coordinate (d_{Tx}(t), d_{Ty}(t)) using the following formula.
(d_{Tx}(t)−x_{R})²+(d_{Ty}(t)−y_{R})=(d_{TR}(t))² (16)
Where (x_{R},y_{R}) is the position of receiver R in terms of this coordinate system. Substituting the above into equation 15 gives:
Δφ_{TR}^{corr}(C)=(N_{A}−N_{B})[φ_{Tf}(C)+f_{clk}/c[(d_{Tx}(C)−x_{R})²+(d_{Ty}(C)−y_{R})^{1/2}]] (17)

Therefore, there are now three unknowns (d_{Tx}(C), d_{Ty}(c), and φ_{Tf}(C)) and three measurements (Δφ_{TR}^{corr}(C)), from which these unknowns can be calculated. As mentioned above, in this example, an iterative numerical reduction method is used to solve for these unknowns. This is done by firstly defining, the function fᵢ(C) for each of the measurements (i) which equals the right hand side of equation 17 minus the left hand side. This function fᵢ(C) should be equal to zero, however, due to approximations and other errors, it is likely that there will be a slight offset from zero. The position determination unit 76 then finds the values of the unknowns which minimise the sum of squares of these functions fᵢ(C), ie:

$$F ( {d}_{Tx} , {d}_{Ty} , {ϕ}_{Tf} ) = {\sum }_{i = 1}^{3} {f}_{i}^{2} ( C ) \qquad ( 18 )$$

As this is a continuous and differentiable function, a set of partial derivatives of F for d_{Tx}(C), d_{Ty}(C) and φ_{Tf}(C) are derived and the equation solved numerically.

This is done using the Broyden-Fletcher-Goldfarb-Shanno method which is a variant of the Davidon-Fletcher-Powell algorithm. This is a standard minimisation algorithm which finds the values of the unknown variables that minimise F and therefore a further description of it shall be omitted. The reader is referred to the publication “Numerical recipes in C,” by Press, Teukoisky, Vettering and Flannery-for further details of this algorithm.

### THIRD EXAMPLE

In the first and second examples described above, the position of a single mobile tag was determined and then tracked. A third example will now be described in which there is more than one mobile tag 2 to be tracked. FIG. 11 is a schematic flow chart illustrating the operation of this example for tracking. N tags simultaneously. At step s11-1, tag 1 transmits a chirp. This chirp is received by receivers 1, 2 and 3 at steps S11-3, S11-5 and S11-7 respectively. Each of the receivers 1, 2 and 3 processes the chirp and transmits the phase measurement data to the position processor. In step S11-9, tag 2 transmits a chirp. This chirp is received by receivers 1, 2 and 3 at steps s11-11, S11-13 and S11-15 respectively. Again, the receivers process the received chirp and transmit the phase measurement data to the position processor. This process continues until the last tag, tag N, transmits a chirp at step S1′-17 which chirp is received by the receivers 1, 2 and 3 at steps S11-19, S11-21 and S11-23 respectively. Thereafter tag 1 transmits another chirp followed by tag 2 etc. As before, the receivers 1, 2 and 3 process each received chirp and transmit the phase measurement data to the position processor 4. When the position processor receives the phase measurements for a tag, it immediately calculates the position and clock offset for that tag at step S11-25.

As those skilled in the art will appreciate, provided that each tag transmits on different frequencies, it is possible for all of the tags to transmit simultaneously. Alternatively, if frequencies are to be shared between the tags, then it is necessary for at least those tags sharing a frequency to transmit at different times. In this example, however, each of the tags transmits on different frequencies so that the phase measurements received from the receivers can more easily be associated with the tag that transmitted the chirp. In the alternative example where tags share frequencies, either the system must know when each tag is transmitting, or it must be able to deduce this from the determined position and from the previous positions of the tags that are sharing frequencies or some tag ID must be transmitted with the tones.

Referring now to FIG. 12, the functional elements of the position processor 4 used in this example will now be described in more detail. The data receiver 70, the measurement alignment unit 72, the phase measurement subtraction unit 74, the network calibration unit 78, the adder 80 and the position determination unit 76 all operate in the same way as the corresponding elements of the second example described above. However the output from the position determination unit 76 is, in the present example, output to a clock offset processing unit 82 and a path processing unit 84. The clock offset processing unit 82 provides a feedback estimate of the phase of the mobile tag's clock relative to that of the fixed tag (φ_{Tf}(C)) for each tag 2 to the position determination unit 76, in order to speed up the minimisation algorithm. In this example, the clock offset processing unit 82 calculates the feedback estimates by considering the history of the relative phase for a mobile tag and the fixed tag and extrapolating from it to provide an estimated phase at the next chirp. This phase estimate is then used by the algorithms in the position determination unit 76 as a starting estimate for the relative phase (φ_{Tf}(C)) during the processing of the signals from the next chirp from that tag 2.

The path processing unit 84 applies certain physical rules to the position data output by the position determination unit 76 to ensure that the position solution does not alter in such a fashion that would imply a physically impossible movement of the tag 2. For example, if the tags are constrained to move over a predetermined course, then positions outside this course must be invalid and so those position solutions are not allowed. The path processing unit 84 also uses time averaging to determine velocity information for each tag 2 and thus the output from the path processing unit 84 is, in this example, a position and velocity for each mobile tag 2. As shown in FIG. 12, the output of the path processing unit 84 is also fed back into the position determination unit 76, also to provide starting estimates for the minimisation algorithm for that tag at the next chirp. This estimate is determined, in this example, using the determined velocity measurement and the time between chirps from that tag.

### FOURTH EXAMPLE

Overview

A number of examples have been described above which illustrate the way in which the position of one or more moveable tags can be determined relative to a number of receivers. A fourth example will now be described with reference to FIGS. 13 to 17 of a prototype system that has been built for determining and tracking the position of a number of horses around a racing track. FIG. 13 is a schematic diagram illustrating the racing track 199 and showing three horses 200-1, 200-2 and 200-3 with associated riders 201-1, 201-2, 201-3 racing around the racing track 199. Attached to each rider 201 is a tag 2 which is similar to the mobile tag described in the above examples. In this example, there are four receivers 3-1, 3-2, 3-3 and 3-4 which receive the chirps transmitted by the mobile tags 2. In this example, there are also two fixed tags (not shown) which are the same as the fixed tags used in the second example and used for the same purpose. FIG. 13 also shows a chirp that is transmitted by tag 2-1. In this example, the tags 2 are arranged to share transmission frequencies but the chirp repetition rate for each tag is different in order to minimise collisions caused by two tags transmitting at the same frequency at the same time. In this example, each chirp also includes a tag ID frequency which is unique and used to ensure that the correct phase measurements are associated with the correct tags.

Tag

FIG. 14 is a schematic block diagram illustrating the main functional components of the tags 2 carried by the riders 201. As before, an FPGA 10 receives a clock input (which is in the present example is at 13 MHz) from the clock 11 and provides instructions to a DDS 12 to generate the required tone signals. As will be described below with reference to FIG. 15a in this example, each chirp comprises a predetermined pattern of six different tones. The FPGA 10 also receives data defining a tag ID frequency from the tag ID store 13. This tag ID data defines a unique ID frequency associated with the particular tag 2. This tag ID data is also provided by the FPGA 10 to the DDS 12 so that a tone with the frequency F_{ID} can be generated by the DDS 12. The tones generated by the DDS 12 are generated at a frequency of approximately 70 MHz and require conversion into analogue signals and mixing up to the transmission frequency at approximately 2.45 GHz. In the present example, this is achieved using the DAC 14 and a two-stage mixing process using mixers 16 and 27. In this example, mixer 16 receives a mixing signal from a first local oscillator 18 whose frequency is also controlled by the FPGA 10. The mixer 16 up coverts the tones from the DDS 12 to an intermediate frequency at approximately 450 MHz. The mixed signal is then filtered by the bandpass filter 20 to remove unwanted frequency components of the mixing operation and is then input to the second mixer 27. As shown, the second mixer 27 receives the mixing signal from a second local oscillator 26 whose frequency again is controlled by the FPGA 10. The frequency of the second mixing signal is such as to cause the tones output from the DDS 12 to be mixed up to a frequency of approximately 2.45 GHz. This signal is then filtered by the bandpass filter 28, again to remove unwanted frequency components from the mixing operation. The filtered signal is then amplified by the power amplifier 22 before being transmitted from the transmit antenna 24.

In the first example described above, each chirp included two tones (tone A and tone B). The use of two tones in this way allowed the determination of phase difference measurements which increased the range over which an absolute position measurement could be obtained. As those skilled in the art will appreciate, it is possible to further improve this system by introducing more tones into the chirp so that more tone differences can be calculated. The form of the chirps transmitted by each of the tags 2 in this example will now be described with reference to FIG. 15. In particular, FIG. 15a shows the tone pattern of the chirp, which is a sequence of seven tones. The chirp begins with a tone at frequency f₀ which is transmitted for 1 ms. This initial part of the chirp is used a “warm-up” signal and is not used for position calculation. It is there to allow the components in the transmitter and the receiver to warm-up in order to reduce signal degradation in the subsequent tones. Following the transmission of the tone at frequency f₀, four tones with frequencies f₁, f₂, f₃ and f₄ are transmitted in sequence each for 0.3 ms, followed by another tone at frequency f₀ again for 0.3 ms. In this example, these four tones and the second burst of the f₀ tone are used for position calculations. Following the second tone at frequency f₀, the ID tone (as up converted through the mixers) at a frequency of f_{ID} is transmitted. As mentioned above, the ID frequency is unique for the respective tags 2 which allows the receivers (and/or the position processor) to identify the tag which transmitted the current chirp phase measurements that are being processed.

FIG. 15b illustrates the spread of frequencies that are transmitted over the tone. As shown, frequency f, is higher than f₀ and frequencies f₂, f₃ and f₄ are lower than frequency f₀ by differing amounts. By considering the tone f₀ as a centre frequency around which the others are generated, the exact frequency differences between these tones in this example are:

| Tone | Frequency relative to f₀ |
|---|---|
| f₀ | 0 MHz |
| f₁ | +5.12890625 MHz |
| f₂ | −0.1015625 MHz |
| f₃ | −0.7109375 MHz |
| f₄ | −4.82421875 MHz |
| f_{ID} | unique for each tag |

f_{ID} is generated in the present example to be f₀, plus or minus 0 to 32 times 101.5625 kHz, yielding a maximum of 65 tags. It should be noted that all of the frequencies f, to f₄ and f_{ID} are integer multiples of 50.78125 kHz which is used as a base frequency in the tags 2 and the receivers 3. As mentioned above, the chirp repetition intervals for each of the tags are different but are all approximately 100 ms. The exact repetition rates are chosen to ensure that each chirp starts from the zero phase point of the 50.78125 kHz basic reference frequency discussed above. This basic reference frequency represents the granularity of the frequency spacing for the tones within the chirp and is the basic “bin width” of the FFT used in the DSP 42 of the receiver 3 for extracting the tone phases. The 50.78125 kHz base frequency is generated as 1/256 of the 13 MHz clock oscillator frequency.

These frequency spacings allow the calculation of the following frequency differences between the tones: one difference of approximately 0.1 MHz (f₀−f₂) two differences of approximately 0.7 MHz (f₂−f₃=0.6 MHz and f₀−f₃=0.7 MHz) and five differences of approximately 5 MHz (f₁−f₀=5.1 MHz, f₁−f₂=5.2 MHz, f₀−f₄=4.8 MHz, f₂−f₄=4.7 MHz and f₃−f₄=4.1 MHz). These phase differences allow a coarse position measurement to be calculated using the 0.1 MHz phase difference measurements (which corresponds to a maximum unambiguous distance of approximately 3000 m), an intermediate position measurement to be calculated using the 0.7 MHz phase difference measurements (which correspond to a maximum unambiguous distance of approximately 430 m) and a fine position measurement to be calculated using the 5 MHz phase difference measurements (which corresponds to a maximum unambiguous distance approximately 60 m). Referring to FIG. 16, in the present example, the position processor operates initially using only the 0.1 MHz difference signal (illustrated in FIG. 16a) to obtain a coarse position measurement. It then uses this coarse position measurement to identify the correct phase cycle of the 0.7 MHz difference signal (illustrated in FIG. 16b) from which a medium accuracy measurement is determined. Finally, it uses this medium accuracy measurement to identify the correct phase cycle of the 5 MHz difference signal (illustrated in FIG. 16c) from which a fine position measurement is determined.

Receiver

The receivers 3 used in this example are substantially the same as those used in the second example described above. However, there are some differences in the structure of the analogue to digital converter and the digital signal processor that are used. These differences are mainly designed to ensure that the system can be operated using a Pentium III PC compatible computer. FIG. 17 is a schematic block diagram illustrating the main components of the ADC 40 and the DSP 42 used in this example. As shown, the ADC 40 comprises two identical 12 bit ADCs 41a and 41b each of which receive the same input signal from the filter 38 (see FIG. 5). As in the second example, each of the ADCs 41a and 41b is configured to undersample the signal at 52 megasamples per second. This produces a signal image centred at 18 MHz. The output from the ADC 41a is passed to DSP 42 where it is fed to a first mixing and decimation unit 48a and the output from ADC 41b is passed to the DSP 42 where it is fed to a second mixing and decimation unit 48b. As shown in FIG. 17, the data stream from ADC 41a is passed first into a complex digital local oscillator (DLO) 120a which, in this example, mixes the data stream with a 15.4609375 MHz mixing signal. As it is a complex DLO, the output from the DLO 120a comprises both in phase (I) and quadrature phase (Q) samples. Each of the (I) and (Q) sample streams are then low pass filtered by a respective low pass filter 122a and 122b which have a 1 dB cut-off frequency of 5.2 MHz. The filtered I and Q data streams are then decimated by eight down to a sample rate of 6.5 megasamples per second by the respective decimator units 124a and 124b. The outputs of these decimators, which form the output from the mixing and decimation unit 48a, are then passed into a respective buffer 50a and 50b. Blocks of both the in-phase and quadrature phase samples from these buffers are then input to an FFT unit 52a which performs a complex FFT in the manner described above in the second example. In this example, however, the FFT unit 52a performs a 128 point complex FFT rather than a 256 point FFT.

The digital samples output from the ADC 41b are passed to a complex digital local oscillator 120b which, in this example, mixes the data stream with a 20.5390625 MHz mixing signal. The output in-phase and quadrature phase data streams are then low pass filtered by a respective low pass filter 122c and 122d, both of which have a 1 dB cut-off frequency of 5.2 MHz. The filtered I and Q data streams are then decimated by eight down to a sample rate of 6.5 megasamples per second by the decimator units 124c and 124d. The outputs from these decimators are then input to a respective buffer 50c and 50d. Again, blocks of 128 in-phase and quadrature phase samples from these buffers are then input to an FFT unit 52b which performs a 128 point complex FFT on the samples in the block.

As those skilled in the art will appreciate, by mixing the samples with different mixing frequencies by the DLOs 120a and 120b, different parts of the spectrum of the received signal are evaluated by the two channels. With the sample rates used and the number of points considered in the FFT, this means that each frequency bin of the FFT outputs represents 50.78125 kHz of frequency spectrum, with the entire FFT output from the FFT unit 52a representing the lower 6.5 MHz of the received signal spectrum and the output of the FFT unit 52b representing the upper 6.5 MHz of the received signal spectrum. The parts of the spectrum that are processed by the two channels are illustrated in FIG. 18. The dashed plot 121 illustrates the part of the signal spectrum that is analysed by the FFT unit 52a and the plot 123 illustrates the part of the signal spectrum that is analysed by the FFT unit 52b. The sloping off of the ends of these plots illustrate the effects of the cut-off rate of the low-pass filters 122 used in the respective channels. As illustrated by the hatched area 125, there is an overlap region centred at 18 MHz (which corresponds to the f₀ frequency tone). The location of the other tone signals within the chirp are also shown in FIG. 18 for information. In this example, the mixing frequencies have been chosen so that the frequency bins match in the overlap region 125 so that they can be merged together into a single FFT array spanning the desired range of frequencies for the tag chirp. The result is similar to what would have been achieved using a single processing channel operating at 13 megasamples per second and using an FFT unit that carries out a 256 point FFT.

As shown in FIG. 17, the output from the FFT units 52a and 52b are input to the signal comparison unit 54 where the amplitude values of the FFTs are compared with the amplitude threshold 56 in order to detect the beginning of a chirp. In this example, this is done by detecting the presence of a signal in the FFT output which corresponds to the f₀ frequency tone which is transmitted at the beginning of each chirp. When the beginning of a chirp is detected in this way, the amplitude signals in each FFT frequency bin corresponding with known tone frequencies are used to construct a matrix having 5 rows (one for each tone frequency) and 180 columns (for 180 consecutive FFT outputs, which corresponds to approximately 3.5 ms of received signal) which is sufficient to span an entire chirp. The pattern matching unit 64 then compares this pattern of FFT values stored in the buffer 62 with the reference pattern 66 which represents an ideal chirp response. This ideal chirp response is similar to the tone pattern shown in FIG. 15b. However it is not exactly the same since, in this example, the frequency of tone f₀ lies within the overlap region 125 of the two FFTs. Therefore, when tone f₀ is being transmitted, the output from both of the FFT units 52a and 52b will include amplitude and phase values corresponding to that tone. Further, as shown in FIG. 18, tone f₂ lies just outside the region 125 and will not be significantly attenuated by the low pass filters 122. Therefore, tone f₂ will also be represented in the output from both FFT units 52a and 52b. However, this is easily represented within the reference pattern and does not pose a problem to the pattern matching unit 64.

In this example, the pattern matching unit 64 compares the pattern of FFT values stored in the buffer 62 by cross-correlating the reference pattern with the data in the buffer 62. This identifies the time offset of the chirp within the sample set, and this time offset is used to determine the time base for the chirp in terms of the receiver's clock. This time offset is also used to determine the optimum time slots for the presence of each tone within the data in the buffer 62. Once a chirp has been identified within the data stored in the buffer 62, the control unit 58 determines the tag ID from the received f_{ID} frequency and extracts an amplitude measurement, a phase offset measurement and a phase slope measurement for the other tones in the chirp. Further, in this example, the control unit 58 determines two sets of amplitude, phase offset and phase slope measurements for the f₀ tone, one from the data received from each of the two FFT units 52a and 52b. This is possible, since the f₀ frequency appears in the spectrum of the received signal which corresponds to the usable overlap region 125 from the outputs of the FFT units 52. Similarly, two sets of measurements could have been obtained for the f₂ tone. However, this was not done in this example.

These amplitude, phase offset and phase slope measurements are then transmitted from the receiver to the position processor together with data identifying the receiver ID, the receiver time for the chirp and the tag ID. As in the examples described above, this message is transmitted via a wireless network to the position processor 4 as soon as it has been calculated.

In this example, each receiver 3 is arranged to operate in three different modes, with the mode being selected by the receiver according to the circumstances at that time. The three modes are a scan mode, a collect mode, and a refresh mode.

In the scan mode, the output from one of the FFT units 52 is processed by the signal comparison unit 54. In this example, this processing involves checking the frequency bin of the FFT output corresponding to the f₀ frequency for the presence of a signal. This is determined by comparing the amplitude value for the corresponding FFT bin against the fixed threshold which needs to be exceeded for a predetermined number (in this example 5) of consecutive FFT outputs. When this occurs, the receiver is switched to the collect mode.

In the collect mode, the second processing channel is activated so that both channels are working in parallel to process the received data as described above with reference to FIGS. 17 and 18. During the collect mode, the frequency bins for the relevant tones are stacked into the buffer 62. As discussed above, this continues for 180 FFT outputs (corresponding to approximately 3.5 milliseconds of transmitted signal) which is enough to capture all of the transmitted chirp. This data is then processed to extract the amplitude, phase offset and phase slope values as discussed above and then the operating mode of the receiver is switched to the refresh mode.

In the refresh mode, the receiver operates in exactly the same way as in the scan mode except that it is waiting for the absence of the signal at the f₀ frequency, at which point it returns to the scan mode discussed above.

Position Processor

The operation of the position processor 4 used in this example will now be described with reference to FIGS. 19 and 20. The data received from each receiver 3 is received by the data receiver 70 and passed to the measurement alignment unit 72 as before. The received data is also stored in a data store 71 for subsequent retrieval and processing. Storing the data in this way allows the system to reprocess the data off-line which can be used to debug the system and for comparative testing for algorithm development. In the measurement alignment unit 72, the incoming data packets, each containing the data of a single tag chirp from one receiver, are queued in a first in, time sequenced out queue. The time sequencing is based on the receiver time tags appended to the chirp data. Since each receiver has its own asynchronous clock, these time tags are referenced to the position processor's clock using a clock difference derived statistically from a large number of received packets. This statistically derived clock offset is not used in the position processing algorithms but it is needed to determine the association between chirps received at the different receivers. It only needs to have an error smaller than half the minimum chirp interval which in this example is approximately 46 ms. The chirps are then drawn out from this queue in time sequence and passed to a quality assessment (QA) and collision detection unit 73 via a set of chirp smoothing filters (not shown).

The chirp smoothing filters are used to smooth out variations in the determined phase slope measurements for each of the tones. A respective smoothing filter is provided to smooth the chirp data from each receiver for each tone from each tag. Therefore, in this example, there are a hundred (5 tones×4 receivers×5 tags) chirp smoothing filters. Smoothing is done since the phase slope measurements for a tone should not change significantly from one chirp to the next. Therefore, in this example, each chirp smoothing filter performs a running average calculation over a predetermined length of time on the corresponding phase slope measurements. In this example, the chirp smoothing filters associated with the fixed tags 5 carry out a running average over approximately one hundred seconds worth of chirps and the chirp smoothing filters associated with the mobile tags carry out a running average over approximately ten seconds worth of chirps. The smoothed phase slope measurements output from these chirp smoothing filters are then used in the subsequent analysis.

The QA and collision detection unit 73 operates to identify collisions (ie when two tags are transmitting at the same time) and to discard the chirp data when this occurs. In this example, this is done using knowledge about the chirp repetition rates of each tag. In particular, the QA and collision detection unit 73 monitors the chirp repetition rates of each tag and each time a reported chirp is received, the QA and collision detection unit 73 checks whether any two tags were scheduled to transmit at that time. If they are then the data for that chirp is automatically discarded. The chirp data is also subjected to a set of consistency checks that test the amplitude and phase slope measurements for variation from one chirp to the next. In particular, if these values change significantly from one chirp to the next or if the phase slope measurements for a single chirp differ substantially, then again the data for that chirp is discarded. In this example, the QA and collision detection unit 73 also compares the received tag IDs against a list of allowed tags and the received data for the chirp is discarded if the tag ID is not on this list.

The chirp data that is not discarded by the QA and collision detection rate 73 is then passed to the phase measurement determination unit 74 where the following phase subtraction measurements are calculated:

| Phase | |
|---|---|
| difference | |
| measurements | Beat frequency |
| Δφ₀ | f₀ − f₂ = 0.1 MHz (from channel 1 of |
| | the ADC) |
| Δφ₁ | f₀ − f₂ = 0.1 MHz (from channel 2 of |
| | the ADC) |
| Δφ₂ | f₂ − f₃ = 0.6 MHz |
| Δφ₃ | f₀ − f₃ = 0.7 MHz |
| Δφ₄ | f₁ − f₀ = 5.1 MHz |
| Δφ₅ | f₁ − f₂ = 5.2 MHz |
| Δφ₆ | f₀ − f₄ = 4.8 MHz |
| Δφ₇ | f₂ − f₄ = 4.7 MHz |
| Δφ₈ | f₃ − f₄ = 4.1 MHz |

Each phase difference measurement is calculated by referring the two tone phase offsets concerned to the time point between the two tones using the phase slope measurements for the chirp to extrapolate to the common time, and then subtracting them. As in the second example, the phase offset measurement for each tone is taken at a time corresponding to the middle of the tone and this value is extrapolated using the associated phase slope measurement to the point in time midway between the two tones being subtracted. For example, referring to FIG. 15b, in the case of the subtraction the phase measurements for f₀ and f₃ this time point lies somewhere in the middle of the tone at frequency f₄. As mentioned above it is these extrapolated values (which represent what the expected tone's phases would be at the same point in time) that are subtracted. These phase differences are represented as an absolute phase value at the measurement time and a phase slope. This phase slope is initialised by subtracting the two phase slope measurements for the two tones being subtracted and is thereafter maintained by a phase locked loop which tracks the phase difference between chirps. Further, since the difference frequencies may undergo several cycles of phase rotation between chirps (depending on the relative clock frequency offsets between the tag and the receiver), the phase difference measurement is tracked between chirps.

FIG. 20 is a schematic block diagram illustrating the form of the phase difference tracking loop used in this example. The loop is essentially a proportional and integral tracking control loop. The loop maintains estimators of the phase difference offset value (Δφ₀^{A-B}) output from block 205 and of the phase difference slope value (Δφₛ^{A-B}) output from the block 203. The estimators operate each time data for the corresponding chirp is received and at that time, the estimator values are updated. As shown, upon receipt of new phase offset measurements for the two tones (labelled A and B), these are differenced in the adder 205. The current phase difference offset value from the estimator block 201 is then subtracted from this value in the adder 207 to provide an error value (ξ). This error value then passes through the loop gain 209 and the low pass filter 211.

The filtered error signal is then used to update the phase difference slope value stored in the block 203. As shown in FIG. 20, it does this by passing the error signal through a second amplifier block 213 and then subtracting from this value, in the adder 215, the value of the previous phase difference slope value provided by the delay unit 217.

This new phase difference slope value is then used to update the phase difference offset value stored in the block 201. It does this firstly by multiplying the new phase difference slope value in the multiplier 219 with the time between the last chirp and the current chirp, which is provided by the chirp interval unit 221. This value is then added together with a further amplified version of the error signal output from the amplifier 223 and the previous value of the phase difference offset value provided via the delay unit 225. As shown, these values are added in the adder 227. This new value of the phase difference offset value is then stored in the block 201 for use at the next chirp time.

As shown in FIG. 20, this new phase offset value is also output on the line 231 for use in the position calculation algorithms discussed in more detail below. Once this loop has locked onto the signals, it can also be used to provide an estimate of the phase difference offset at an arbitrary time (τ) and not just at the chirp times. As shown, this is achieved by multiplying the current estimate of the phase difference slope value obtained from block 203 with the time (τ) in the multiplier 235 and then by adding this to the current estimate of the phase difference offset value output from the block 201 in the adder 237.

As those skilled in the art will appreciate, a separate phase locked loop (PLL) is provided for each phase difference measurement that is calculated, for each tag and for each receiver. Therefore, in this example, with nine phase differences, three mobile tags, two fixed tags and four receivers, this means there are 180 phase locked loops like the one shown in FIG. 20.

System Calibration

As mentioned above, the receivers 3 operate independently of each other and they each have their own unsynchronised clock. As in the second and third examples described above, the position processor 4 uses the phase difference measurements obtained from the fixed receivers to reference the phase measurements from the mobile tags 2 back to a single reference clock. In this example, each fixed tag and each measured phase difference for a mobile tag is treated independently so that, in this example, there are two independent reference clocks and different phase measurements associated with each.

For each fixed tag (M) and each phase difference (P) a set of φ^{MRP}(t) values is obtained from the corresponding phase difference tracking loops. Since the positions of the fixed tags and the receivers 3 are known the phase rotation caused by the signal propagation paths between the fixed tags and the receivers can be subtracted from these phase difference measurements. This results in a set of modified φ′^{MRP} values for the fixed tags M, receivers R and phase differences P, as though the fixed tags were located at each receiver. By subtracting these phase values from the corresponding phase differences measured from a mobile tag, a phase measurement relative to the fixed tag is derived thereby eliminating the clock effects of the receivers. Again, the phase of each of these modified φ′^{MRP} values is tracked using a separate phase lock loop (not shown) in order to estimate their most likely values at the time of the current position computation for a mobile tag.

Position Calculation

In this example, the position calculation is performed in a similar manner to the way in which it was performed in the second example described above except using the phase difference values output from the phase difference tracking loops (one of which is shown in FIG. 19). Equation 18 given above for F is for a single fixed tag, one phase difference measurement and one mobile tag. Extending it to M fixed tags and P phase difference measurements results in the following function:

$$F ( {d}_{x} , {d}_{y} , {ϕ}_{{TF}_{pm}} , t ) = {\sum }_{m = 1}^{M} {\sum }_{p = 1}^{P} {\sum }_{i = 1}^{R} {k}_{pm} {f}_{ipm}^{2} ( t ) \qquad ( 19 )$$

The value kₚₘ is a weighting factor that allows the different partial sums for different phase measurements and/or fixed tags to be weighted. For example, phase differences corresponding to longer wavelengths may be weighted lower than those associated with the shorter wavelengths, in order to balance the error each contributes. Again, this function can be solved numerically to find best estimates of the values that minimise F-given the received measurements.

In this example, there are two fixed tags, three mobile tags, four receivers and nine phase difference measurements being measured. Therefore, this results in 180 ((2+3)×9×4) individual phase difference measurements. For each mobile tag a set of 72 (2×4×9) phase difference measurements are obtained and there are 18 unknowns−16 unknown clock offsets (φ_{TFpm}) and a two dimensional position. This set of equations therefore contains significant redundancy (more equations than unknowns). However, using additional fixed tags and phase difference measurements has been shown to yield significantly improved robustness and accuracy through spatial diversity, frequency and time diversity and statistical averaging of measurement noise.

Resolving Cyclic Ambiguity

In any phase measuring system there is a cyclic ambiguity that can result in a displacement error of integer multiples of wavelengths. In this example, the short wavelength difference signals are around 5 MHz which corresponds to a wavelength of approximately 60 metres, which means that there is scope of many cycles of ambiguity in the measurement. For this reason, the longer wavelengths are used to resolve the cycle ambiguities. In principle, the long wavelength is used to produce an unambiguous position within the area of coverage and having an error small enough to initialise the medium wavelengths. These produce a more accurate position in the region of the long wavelength estimate and accurate enough to initialise the short wavelengths. The algorithm is then run using the short wavelengths to determine a highly accurate position fix.

Once a position fix has been obtained using the short wavelengths, this position is used to determine an estimate for the position calculation at the next chirp measurement, without having to restart the sequence through the long and medium wavelength steps. Referring to FIG. 18, the clock offset processing unit 82 and the path processing unit 84 are used to provide these estimates for the position calculation for the next chirp. These operate in the same way as the corresponding components in the third example described above.

Once the position processor 4 is in the tracking mode, it still continuously calculates the positions using the long and medium wavelength measurements as well. The output from the position processor 4 is taken from the short wavelength measurements, unless it is indicated as being invalid. In particular, the position measurements output for the different wavelength measurements are continually compared in order to sense gross errors. If an error occurs, then the position determination unit will detect this and correct for it by discarding the position from the shorter wavelength measurements.

Even when operating in the tracking mode it is still possible, for example because of fast motion of the tags, for there to be an error in the cycle count for one or more of the phase difference measurements. Therefore, in this example, the position processor 4 performs a series of tests and iterations before arriving at the “best” position solution. In particular, the position processor 4 performs the following processing steps for each positioning update using the short wavelength measurements:
(i) Construct a matrix of R×M×P measurements from the measured phase differences plus the calibration phase differences (where R is the number of receivers, M is the number of fixed tags and P is the number of phase difference measurements corresponding to the short wavelengths (which in this example is 5)).
(ii) Feed each of the R×M×P measurements through a respective phase locked loop (similar to the PLL shown in FIG. 20), the output of which is a smoothed “phase estimator” which is used in the position calculation.
(iii) Feed the set of M×P network phases ((φ_{TFpm}) through a respective phase locked loop (again similar to the PLL shown in FIG. 20), the outputs of which are used to estimate their most likely values at the time of the current position computation.
(iv) Based on the last known position for the tag, and hence the path distances in wavelengths between the tag and each receiver, the estimated network phases (φ_{TFpm}) and the measured phases, determine a matrix of R×M×P cycle counts.

(v) Run the minimisation algorithm to derive the best fit position (dₓ, d_{y}) and network phases (φ_{TFpm}) as well as the overall function value of function F; and determine a matrix of error residuals representing the error contribution of all of the individual fᵢₚₘ equations.
(vi) Using the values of dₓ, d_{y} and (φ_{TFpm} obtained from step (v), calculate new range phases and a new matrix of cycle counts. (The range phase is the phase value that is measured corresponding to the distance between the receiver and the tag ignoring the cycle count. In particular, given a signal of wavelength λ and distance between the receiver and the tag of d, the phase comprises the cycle count which is the integer part of d/λ and the range phase which is the fractional part of d/λ).
(vii) Return to step (v) until the obtained function value for function F is equal to or greater than the previous value at which point further minimisation is not being achieved.
(viii) Examine the individual error residuals matrix (i.e. the individual values of fᵢₚₘ) to find the largest residual error and increment or decrement the cycle count corresponding to that measurement set depending on the sign of the error.
(ix) Return to step (v) until the obtained function value for function F is equal to or greater than the previous value at which point no further minimisation is being achieved.

(x) Disable the measurement set corresponding with the worst remaining residual error and then return to step (v) a small (configurable) number of times, to eliminate the worst few phase paths from the position calculation.

The output of this process is then used in this example as the “best” estimate of the mobile tag position and the network phase values for the set of measurements.

Initialisation

The position processor 4 goes through a series of stages from the initial start up to full tracking mode. In this example, these various stages are controlled by interlocking state machines running for each tag and for the system state as whole.

The first state machine is for system start up and calibration. It runs independent processing calculations for each fixed tag and reaches the final system calibrated stage only when the required number of fixed tags have reached this state. The processing for each fixed tag is as follows:
(i) Determine the initial chirp phase offset and slope values by direct measurement.
(ii) Allow the chirp smoothing filter (used to smooth the phase slope measurements) to settle.
(iii) Initialise the chirp phase difference tracking PLLs (shown in FIG. 20).
(iv) Allow the chirp phase difference tracking PLLs to settle.
(v) Wait for a required number of receivers to acquire lock then set the tag synchronisation flag.
(vi) Wait for the required number of fixed tags to signal synchronisation before moving to step (vii).
(vii) Set the system calibrated status once time synchronisation has been achieved.

The system start up state machine takes several minutes to initialise. This allows time for the receivers to stabilise and for statistical time synchronisation of the receivers to be achieved. Also the filter and phase locked loop time constants for the fixed tags are normally quite long compared to those for the mobile tags.

The second state machine is for mobile tag initialisation and position processing. This operates as follows:
(i) Initialise the phase offset and slope values by direct measurement.
(ii) Allow the chirp smoothing filter to settle.
(iii) Initialise the chirp phase difference tracking PLLs.
(iv) Allow the chirp phase difference tracking PLLs to settle.
(v) Wait for the required number of receivers to acquire lock.
(vi) Wait for system calibrated status.
(vii) Compute the initial tag position using the longest wavelength inputting the determined position into a position smoothing filter (not shown) associated with the long wavelength and wait for this filter to settle.
(viii) Compute the tag position using the medium wavelength initialised by the position from the long wavelength and feed the results into a medium wavelength position smoothing filter (not shown) and wait for this filter to settle.
(ix) Compute the tag position using the short wavelengths initialised by the position from the medium wavelength. Search the cyclic ambiguities for the best solution. If the function error residual test shows an acceptable solution move to tracking mode.
(x) Track the position using the short wavelengths. Run the medium and long wavelengths in parallel to test for cycle jump error conditions.

The filter and tracking time constants for the mobile tags are quite short and thus it is possible for this state machine to advance all the way to full tracking mode in as little as 10 seconds in this example.

Although the above processes are described as being “one-way”, they can be restarted under a number of error conditions. For example, if a chirp from one tag is not received for a predetermined length of time (such as 10 seconds), its state machine can be reset appropriately. Similarly, if the short wavelength is found to be tracking with a cycle offset, the position can be re-initialised starting with the medium or longer wavelengths depending on the severity of the error.

Returning to FIG. 18, the final position determinations determined by the path processing unit 84 are output to a motion fitting/time alignment unit 150. This unit allows tag positions for each of the mobile tags 2 to be calculated for any arbitrary time, rather than the specific time at which the tag transmitted its chirp. It is necessary to time align the position data especially since a galloping horse can cover approximately 1.7 metres between chirps. The smoothing and motion algorithms used by the unit 150 apply a least squares straight line fitting algorithm to the determined x and y positions over the past few seconds worth of data. Time aligned sets of position data for all of the mobile tags 2 are then extracted on a predetermined time base, using the straight line fit parameters. In this example, this position data is then transmitted over the Internet 152 to a remote race simulation unit 154. The data is also stored in a data store 153 so that it can be used subsequently for simulation purposes. In this example, the remote race simulation unit 154 uses a graphical visualisation tool or a 3D game rendering tool which can generate an appropriate simulation of the race from the received position data.

### FIFTH EXAMPLE

In the fourth example, all of the tags transmitted on the same frequency but at different times and with the chirp repetition rate of the tags being different in order to minimise the times at which two tags will transmit at one time. However, as those skilled in the art will appreciate, even with this approach, there is a limit to the number of tags that can be operated within a given bandwidth. An example will now be described in which the centre frequency of the transmitted tones (ie the frequency value of tone f₀) is varied from one chirp to the next in a predetermined manner. This also allows more tags to be operated within a given bandwidth being processed. In particular, if the centre frequency f₀ is frequency hopped in a pseudo random fashion from one chirp to the next, then the probability of two tags transmitting at the same frequency at the same time is very small and therefore a larger number of tags can be tracked.

In such an example, both the mobile tags and the fixed tags would be arranged so that the FPGA 10 is programmed with a known transmit scheme which defines the centre frequency for each chirp transmitted from the tag. Thus the exact values of the frequencies f₀ to f₄ and f_{ID} will change for each chirp. However, the relationship between each of the tones f₀ to f₄ and f_{ID} will remain fixed. In the receivers, each receiver will know which frequencies are capable of serving as the centre frequency f₀ according to the predetermined transmits schemes that are being used. Therefore, in the scan mode of operation, the receivers will scan all of the possible f₀ frequencies simultaneously. The collect mode and the refresh mode for each receiver will then work in the same way as in the fourth example described above. In such an example, the receiver would also transmit data to the position processor 4 which identifies the centre frequency f₀ of the received chirp.

Upon receipt of the data from the receivers at the position processor 4, the QA and collision detection unit 73 can monitor for collision detections using the known transmit schemes for each of the tags. In particular, by comparing the transmit scheme for each tag against the transmits schemes of the other tags, based on the recently received chirps for each tag, the QA and collision detection unit 73 can look ahead and predict when collisions can be expected. When the data for these chirps are received they can then be discarded.

The use of such frequency hopping schemes in the tags also reduces the system's susceptibility to narrow band interference. In particular, in the fourth example described above, if there is a source of interference over the transmission frequencies being used, then all of the chirp data is likely to be corrupted by noise. However, by frequency hopping the system's susceptibility to interference is reduced.

### SIXTH EXAMPLE

As a further alternative to frequency hopping, each of the tags may be arranged to transmit a spread spectrum signal rather than simple tones. A sixth example will now be described which uses tags which transmits spread spectrum signals.

FIG. 21 is a functional block diagram illustrating the main components of the tag 2 used in this example. As shown, the tag includes a signal generator 90 which receives a clock input from a crystal oscillator (not shown). In response to the clock input, the signal generator 90 generates two tones corresponding to tones A and B of the first three examples. The signal generator 90 also generates a control signal which it outputs to a pseudo-random noise (PN) code generator 92. The PN code generator 92 generates a pseudo-noise code which it outputs to a mixer 91 where the code is mixed with the tones A and B to form the spread spectrum signal. The output from the mixer 91 is then passed to a bandpass filter 94 and onto a power amplifier 96 before being passed to a transmitter antenna 98 for transmission from the tag 2. In this example, the frequency of the two tones A and B output from the signal generator 90 are sufficiently high to allow for direct transmission. However, in an alternative example, the output from the mixer may be up converted to the appropriate transmission frequency.

FIG. 22 is a schematic block diagram illustrating the main components of a receiver 3 used in such an example. As shown, the signals transmitted from the tag 2 are received by the receiver antenna 100. The received signals are then amplified by a low noise amplifier 102 and then down converted to an appropriate intermediate frequency in the mixer 104. As shown, the mixer 104 receives the mixing signal from a local oscillator 106 which receives a clock input from a crystal oscillator (not shown). The down converted signal output from the mixer 104 is then passed through a bandpass filter 108 and then into a cross-correlator 110 where the received signal is correlated with a locally generated version of the pseudo-random noise code used by the tag. The cross correlator can determine the received phase of the signal to an accuracy of approximately one quarter of the chip period of the PN code. The determined phase data output by the cross correlator 110 is then passed directly to a data transmitter 114 which packages the data for transmission to the position processor 4. However, with the phase measurement from the correlator, the position processor can only determine the position of the tag to a resolution of approximately 10 metres. Therefore, in this example, the cross correlator 110 also recovers the carrier tones and outputs these to the DSP 112. In this example, the DSP processes these carrier tones in the same way as the tones were processed in the above examples. The phase information extracted by the DSP 112 is then passed to the data transmitter 114 for onward transmission to the position processor 4 which operates in a similar way to the position processor described above. The only main difference is that the phase measurement obtained directly from the cross correlator 110 is used to provide a coarse position measurement and the phase measurements from the DSP 112 are used to provide an accurate position measurement.

To distinguish between a plurality of mobile tags 2, the system of the present example allocates separate frequencies for each tag to transmit on. Alternatively, the PN code used in each tag could have been made different although this will complicate the structure of the receivers as each will have to correlate the received signal with a number of different locally generated PN codes. Provided that there is sufficient coding gain, i.e. that the cross-correlation sum between different codes is low enough, the signals from each tag may overlap in frequency without causing interference. It is also possible to frequency hop the system to provide additional robustness to narrow band interference, although spread spectrum systems have a very high inherent noise rejection capability.

Six exemplary tag tracking systems have been described above which illustrate the type of tag tracking system in which the present invention can be employed. A description of an embodiment of the present invention will now be given with reference to FIGS. 23 to 27.

### EMBODIMENT

Overview

The embodiment that will now be described is based on the fourth example described above, except there are four mobile tags 2 and two fixed tags 5. Additionally, in this embodiment, each of the mobile tags 2 transmits chirps (pulses) having a unique set of frequencies to ensure that the transmissions of the different mobile tags 2 do not interfere with each other. Further, in this embodiment, it is not assumed that the phase error introduced by the electronics in each receiver 3 is constant over all the different tone frequencies that are received. To compensate for this, the fixed tags 5 are arranged to replicate the tones used by the mobile tags 2. In particular, the fixed tags 5 are arranged to transmit pairs of chirps, with one of the chirps in the pair including the tones used by one of the mobile tags 2, and with the tone frequencies from different mobile tags 2 being transmitted in successive fixed tag 5 chirp pairs.

Mobile Tag

The mobile tags 2 used in this embodiment have the same functional components of the mobile tag 2 shown in FIG. 14. The only difference is in the operation of the FPGA 10 so that each chirp generated by the mobile tag 2 will have the chirp structure shown in FIG. 23. As shown, each mobile tag is arranged to transmit chirps 250 at a repetition rate of once every 12,500 “frames”, where one frame corresponds to the window over which the FFT unit 52 calculates an FFT. In this embodiment, one frame corresponds to 19.692 μs which makes the chirp repetition rate of each mobile tag 2 approximately 0.25 seconds.

As shown in FIG. 23, each chirp 250 transmitted by the mobile tags 2 includes a sequence of five tones. The chirp 250 begins with a tone at frequency f₀^{M} which is transmitted for 24 frames (i.e. for approximately 0.5 ms). This initial part of the chirp is used as an ID tone and identifies the particular mobile tag 2 to the receivers 3. In this embodiment, the phase measurements for the ID tone are not used in the position calculations.

After the ID tone, the chirp includes four tones with frequencies f₁^{M}, f₂^{M}, f₃^{M} and f₄^{M} which are transmitted in sequence, with tones f₁^{M} and f₄^{M} being transmitted for 48 frames (corresponding to approximately 1 ms) and tones f₂^{M} and f₃^{M} being transmitted for 96 frames (i.e. approximately 2 ms). The phase measurements from these tones are used to calculate the location of the mobile tag 2 and will sometimes, therefore, be referred to hereafter as the “location tones” of the chirp 250. The frequency separations of the location tones have been chosen to allow for the calculation of three different difference frequencies, so that the cyclic ambiguity resulting from phase-wrapping can be resolved in the manner described in the fourth example.

In this embodiment, the frequency difference between frequencies f₁^{M} and f₄^{M} is set at 50.78125 kHz, the frequency difference between tones f₂^{M} and f₄M is set at 710.937 kHz and the frequency difference between tones f₂M and f₃^{M} is 10.15625 MHz. The frequency differences are the same for all of the mobile tags 2 and, as will be described later, for the fixed tags 5. The phase difference measurements obtained for the tones separated by approximately 50 kHz allows for unambiguous position measurement over a range of approximately 6000 m. The phase difference measurements obtained for the tones separated by approximately 711 kHz allows for unambiguous position measurement over a range of approximately 430 m. Finally, the phase difference measurements from the tones separated by approximately 10 MHz will allow for the unambiguous position measurement over a range of approximately 30 m.

The following table gives the frequencies used for the four mobile tags 2 used in this embodiment:

Tag

| Tone | 2-1 | 2-2 | 2-3 | 2-4 |
|---|---|---|---|---|
| f₀^{M} | −30 | −28 | −26 | −24 |
| f₁^{M} | 17 | 21 | 25 | 29 |
| f₂^{M} | 30 | 34 | 38 | 42 |
| f₃^{M} | −170 | −166 | −162 | −158 |
| f₄^{M} | 16 | 20 | 24 | 28 |

where the values in the table correspond to the appropriate values for the variable n in the following equation:

$${f}_{i} = {f}_{carrier} + [ \frac{26 n}{512} MHz ] \qquad ( 20 )$$

where f_{carrier} is the centre frequency of the carrier signal transmitted by each of the mobile tags 2, and in this embodiment is set at 2.4125 GHz.

The durations of the location tones within the chirp 250 are arranged in a symmetric manner so that the tones that will be used to provide the accurate position fix (i.e. tones f₂^{M} and f₃^{M}) have the longest duration, as this minimises the error associated with the phase measurements determined from those tones. Additionally, as will be described in more detail below, the phase measurements for each of the location tones are extrapolated to the time corresponding to the boundary between tones f₂^{M} and f₃^{M}. Again, this time point for the extrapolation has been chosen so that there is minimum extrapolation error for the phase measurements determined for tones f₂^{M} and f₃^{M} used to provide the accurate position fix.

Fixed Tag

The fixed tags 5 used in this embodiment have the same functional components of the tag shown in FIG. 14.

In the examples described above, it was assumed that the phase offset introduced into the measurements by the receiver electronics would be the same for the different received frequency tones. In this embodiment, it is assumed that each receiver 3 will introduce a different receiver phase offset for each of the different tones. The purpose of the fixed tags 5 used in this embodiment is therefore: (i) to account for the lack of synchronisation between the mobile tags 2 and the receivers 3; and (ii) to provide calibration signals to overcome the frequency dependent phase offsets introduced by each of the receivers 3.

The first objective is met by arranging for the fixed tags 5 to transmit chirps having a similar chirp structure to those of the mobile tags 2, so that the appropriate correction values (similar to those defined above in equation (12)) can be applied to the appropriate phase difference measurements. The second objective is achieved, in this embodiment, by arranging for the fixed tags 5 to transmit chirp pairs, with one of the chirps in the pair including the location tones transmitted by a mobile tag 2 and by cycling through the location tones transmitted by the different mobile tags 2.

The chirp sequence and the form of each chirp generated by the fixed tags 5 in this embodiment is shown in Figure 24. As shown, the fixed tags 5 are arranged to transmit pairs of chirps 253 and 255, with the spacing between the pairs corresponding to 65536 frames (approximately 1.3 seconds) and the spacing between the chirps in the pair corresponding to 4096 frames (approximately 80 ms). In this embodiment, the first chirp 253 has the same structure as the chirps 250 generated by the mobile tags 2, except with its own unique set of tone frequencies. In particular, the first chirp has a first ID tone f₀^{F} followed by four location tones f₁^{F} to f₄^{F}. The separations between the location tones f₁^{F} to f₄^{F} of the fixed tags 5 are the same as for the mobile tags 2.

The second chirp 255 in the pair includes a sequence of nine different tones f₀^{F} to f₈^{F}, with the tone frequencies and tone durations of the first five tones f₀^{F} to f₄^{F} being identical with those in the first fixed tag chirp 253. The remaining four tones f₅^{F} to f₈^{F} in the second fixed tag chirp 255 correspond to the location tones f₁^{M} to f₄^{M} used by one of the mobile tags 2. In the next pair of chirps transmitted by the fixed tag 2, the tones f₅^{F} to f₈^{F} in the second chirp 255 will correspond to the frequency tones transmitted by a different one of the mobile tags 2. In this embodiment, there are four mobile tags 2, and therefore the fixed tag 5 requires four pairs of chirps 253, 255 to cycle through all of the location tones transmitted by all of the mobile tags 2.

The following table defines the frequencies and ordering of the transmitted tones in the pairs of chirps transmitted by the two fixed tags 5:

Tag

| | 5-1 | 5-2 |
|---|---|---|
| f₀^{F} | −22 | −20 |
| f₁^{F} | −154 | −150 |
| f₂^{F} | −167 | −163 |
| f₃^{F} | 33 | 37 |
| f₄^{F} | −153 | −149 |

| | Pair | | | | | | | |
|---|---|---|---|---|---|---|---|---|
| | 1 | 2 | 3 | 4 | 1 | 2 | 3 | 4 |
| f₅^{F} | 17 | 21 | 25 | 29 | 17 | 21 | 25 | 29 |
| f₆^{F} | 30 | 34 | 38 | 42 | 30 | 34 | 38 | 42 |
| f₇^{F} | −170 | −166 | −162 | −158 | −170 | −166 | −162 | −158 |
| f₈^{F} | 16 | 20 | 24 | 28 | 16 | 20 | 24 | 28 |

Receiver

The receivers 3 used in this embodiment are substantially the same as those used in the second example described above. FIG. 25 is a schematic block diagram illustrating the main components of the DSP 42 used in this embodiment. As shown, the mixing and decimation unit 48, the buffer 50 and the FFT unit 52 are as before. (A conventional windowing function may be provided prior to the FFT unit 52 to improve frequency separation in the usual way.) In this embodiment, the outputs from the FFT unit 52 (i.e. the amplitude and phase values in the different frequency bins) are passed to a buffer 263 where they are processed by a signal-to-noise ratio (SNR) determining unit 265 and a chirp detection unit 267. The SNR determining unit 265 determines a measure of the signal-to-noise ratio for each of the possible frequency tones that may be transmitted by any of the tags. The SNR determining unit 265 determines the measure of the SNR for a tone by using the amplitude value of the frequency bin corresponding to the tone as a measure of the signal level and the amplitude values from one or more adjacent frequency bins that do not correspond to tones as a measure of the background or noise signal level. The calculated SNR measures are then stored together with the corresponding amplitude and phase values in the buffer 263.

The chirp detection unit 267 is then operable to identify whether or not the output from the FFT unit 52 includes a currently expected ID tone (predicted from the previous chirp that was detected). The ID frequencies and the location frequencies used by each of the mobile tags 2 and the fixed tags 5 are known in advance by the receivers 3 and are stored in the chirp data store 269. When processing the current FFT output, the chirp detection unit 267 checks to see if the SNR measure for the FFT bin corresponding to the expected ID tone is above a predetermined threshold value and/or has increased by more than a predetermined amount from a previous FFT output. If it is, then the chirp detection unit 267 informs the control unit 271 of the new chirp and the tag that generated it.

In response, the control unit 271 identifies the location frequencies that are expected to be transmitted by the identified tag, from the chirp data store 269. The control unit 271 then ensures that the appropriate phase and SNR values for the identified frequencies over the entire chirp are passed to a least squares determining unit 273 which effectively calculates the above described phase slope value (is) and phase offset value ((O) for each of the location tones in the chirp.

As discussed above with reference to FIGS. 23 and 24, each of the tags (both mobile and fixed) transmits an initial ID tone followed by four location tones. The least squares determining unit 273 does not process the phase values from the ID tones, it processes only the phase values from the location tones. As discussed above, tones f₁ and f₄ are transmitted for a duration corresponding to 48 frames and tones f₂ and f₃ are transmitted for a duration corresponding to 96 frames.

There should therefore be 48 phase measurements for tone f₁, 96 phase measurements for tone f₂, 96 phase measurements for tone f₃ and 48 phase measurements for tone f₄. FIG. 26 is a time plot illustrating the best line fits for the phase measurements during each tone that the least squares determining unit 273 determines. As shown, line 301 represents the best line fit to the phase measurements obtained for tone f₁; line 303 represents the best line fit for the phase measurements obtained to tone f₂; line 303 represents the best line fit to the phase measurements obtained for tone f₃; and line 307 represents the best line fit to the phase measurements obtained for tone f₄.

As shown in FIG. 26, the gradients of the lines 301, 303, 305 and 307 are all slightly different. This is because the gradient of the lines is proportional to the frequency of the corresponding tones. In addition to these phase slope measurements, the least squares determining unit 273 also extrapolates the best line fits for each of the tones to a common time point (t_{c}) (which occurs at the boundary between tones f₂ and f₃) to determine a phase offset value for each tone at that common time point. This common time point has been chosen in order to minimise loss in accuracy due to this extrapolation on the measurements for tones f₂ and f₃, since these measurements are used to calculate the accurate position fix. As shown in FIG. 26, plot 301 extrapolates to the phase offset value φ₀₁ at time point t_{c}, plot 303 has a value of φ₀₂ at time point t_{c}, plot 305 has a value φ₀₃ at time point t_{c} and plot 307 extrapolates to the phase value φ₀₄ at time point t_{c}.

The thus determined phase slope values (φₛⱼ) and phase offset values (φₒⱼ) are then passed back to the control unit 271. The control unit 271 then forwards the determined phase slope and phase offset values together with ID data for the tag that generated the chirp and the receiver that received the chirp and a time stamp identifying time t_{c} to the data transmitter 44 for onward transmission to the position processor 4.

In this embodiment, the least squares determining unit 273 also estimates the error on each of the phase slope measurements and the error on each of the phase offset measurements, from how well the measured phase values agree with the best line fits 301, 303, 305 and 307. These error estimates are also transmitted to the position processor 4 and used to weight the measurements in the position calculations, so that less significance is given to estimates having large errors than those with smaller errors.

In this embodiment, the receivers 3 process the pairs of chirps 253, 255 received from the fixed tags 5 in a similar way to the way in which they process the chirps 250 from the mobile tags 2. However, in this embodiment, since each fixed tag 5 is arranged to transmit a pair of chirps, with the second chirp 255 in the pair including a replica of the location tones transmitted by one of the mobile tags 2, the control unit 271 ensures that the least squares determining unit 273 calculates the appropriate phase slope and phase offset values for the replicated mobile tag tones f₅^{F} to f₈^{F} separately from the phase slope and phase offset values for the fixed tag tones f₁^{F} to f₄^{F}.

In this embodiment, the mobile tags 2 do not have to maintain phase coherence between chirps 250. In other words, the starting phase of the tones in each chirp do not have to be the same as they would have been had the tones been continuously transmitted since the previous chirp. Provided the starting phases for all the tones are the same, this unknown starting phase will be removed by the position processor 4 when calculating the appropriate phase difference measurements. In contrast, in this embodiment, the fixed tag 5 is arranged so that there is phase coherence between the transmitted chirps 253, 255. This allows the data from previous chirps to be used by the least squares determining unit 273 in order to determine more accurately the phase slope and phase offset measurements for the current chirp. This is important, because the phase slope and phase offset measurements are used to estimate what the phase of the fixed tag tones would be at the times (t_{c}) when the mobile tag chirps 250 are received. The more accurately the phase slope and phase offset measurements for the fixed tag 5 are determined, the more accurate the network calibration can be made and the less often the fixed tags 5 must transmit their chirps.

FIG. 27 shows the best line fit 311 that is obtained for one of the tones in a single fixed tag chirp by the least squares determining unit 273. This best line fit has an error associated with it depending on how close the measured phase values match the best line fit 311. This error in the phase slope measurement is illustrated in FIG. 27 by the angle γ₁. As shown, with such a large error associated with the phase slope measurement, there may be up to 180° error in the extrapolated value of the appropriate phase offset value by time tₐ₁. Therefore, the next chirp transmitted by the fixed tag 5 must be transmitted before time tₐₗ. However, if the phase measurements obtained for a second chirp received at time t_{c2} are combined with the measurements from the first chirp, then a better estimate of the phase slope for the best line fit 311 can be determined, which will have a smaller error associated with it. This error is represented by the smaller angle γ₂ shown in FIG. 27. As shown, as a result of the smaller error, extrapolating the fixed tag phase offset values may only lead to a phase error of more than 180° beyond time tₐ₂. Therefore, the next chirp does not have to be transmitted until shortly before time ta₂. The chirp structure transmitted by the fixed tags 5 in this embodiment (as shown in FIG. 24) has been chosen so that the measurements from the pairs of chirps can be combined, thereby minimising the number of times the fixed tags 5 have to transmit whilst avoiding ambiguity caused by the error γ.

In order to combine the phase data for the current fixed tag chirp with the phase data from one or more previous fixed tag chirps, the least squares determining unit 273 can use all of the “raw” phase measurements from the previous fixed tag chirps or it can use the determined phase offset measurements calculated for the previous fixed tag chirps. The latter approach is preferred and used in this embodiment since it reduces the amount of data that has to be stored in each of the receivers 3.

Position Processor

The operation of the position processor 4 used in this embodiment is similar to the position processor described with reference to FIGS. 19 and 20 used in the fourth example described above. As before, the data received from each of the receivers 3 is received by the data receiver 70 and passed to the measurement alignment unit 72. The received data is also stored in the data store 71 for subsequent retrieval and processing.

The measurement alignment unit 72 aligns the data from the different receivers for the same chirps. The operation of the measurement alignment unit 72 is made easier in this embodiment because each fixed tag 5 cycles through the location tones transmitted by the mobile tags 2 in a known order and therefore, each pair of chirps transmitted by each fixed tag 5 is effectively labelled. The position processor 4 can therefore work out the time offsets associated with each receiver clock and the latency in the transmission of the data from each receiver 3 to the position processor 4. Knowing the clock offset for each receiver 3 and the network latency, the measurement alignment unit 72 can more easily determine whether the data from each receiver 3 was from the same chirp.

In this embodiment, since each of the mobile tags 2 transmits on different frequencies, the chirps transmitted by the mobile tags 2 will not interfere with each other if they are transmitted at the same time. However, since the fixed tag 5 replicates on a periodic basis the frequencies transmitted by each of the mobile tags 2, it is possible for a collision to occur between a fixed tag 5 chirp transmission and the mobile tag 2 transmission. The QA and collision detection unit 73 operates to identify these collisions and to discard the chirp data when this occurs. The QA and collision detection unit 73 also tracks the phase slope measures for each tone and for each receiver and discards the data for any chirps whose phase slope measures have changed significantly from the previous chirp. The QA and collision detection unit 73 also calculates a weighting for the phase offset measurements calculated for each chirp. In this embodiment, this weighting is calculated based on the measurements of the phase slope and phase offset errors and the average signal-to-noise ratio for each tone in the chirp. This weighting is used so that measurements having low errors and high signal-to-noise ratios are given more weight in the position calculations than measurements having high errors and low signal-to-noise ratios.

The phase slope and offset measurements are then passed to the phase measurement determination unit 74 which calculates the following phase difference measurements:

| | Phase Offset Calculation |
|---|---|
| Phase Difference | (corresponding beat |
| Measurements | frequency) |
| Δφ₀ | φf₁ − φf₄ (50.78125 kHz) |
| Δφ₁ | φf₂ − φf₄ (710.937 kHz) |
| Δφ₂ | φf₂ − φf₃ (10.15625 MHz) |

In this embodiment, since each of the phase offset measurements has been determined at the common time point t_{c}, the phase difference calculations are calculated directly from the received phase offset measurements.

System Calibration

As in the fourth example described above, the receivers 3 operate independently of each other and they each have their own unsynchronised clock. However, the position processor 4 uses the phase difference measurements obtained from the fixed tag 5 chirp measurements (as extrapolated to the time point (t_{c}) of the mobile chirp) to reference the phase measurements from the mobile tags 2 back to a single reference clock.

As discussed above, the difference in frequency between tones f₁ and f₄ and between tones f₂ and f₄ and between tones f₂ and f₃ are the same for all of the mobile tags 2 and the fixed tags 5. As a result, the phase difference measurements obtained from the fixed tag 5 tones can be used to calibrate the corresponding phase difference measurements obtained from the mobile tags 2. However, as discussed above, in this embodiment, the receivers 3 introduce a frequency dependent phase offset into each phase measurement. This frequency dependent phase offset will therefore introduce an error into the phase difference calculations (because they do not cancel each other out), unless it is also taken into account by the network calibration unit 78. The way in which this frequency dependent phase offset is removed in this embodiment will now be described.

When the phase difference measurement for mobile tag tones A and B is calculated from the phase measurements determined by receiver R, the phase difference measurement is given by:
Δφ_{AB}=Δφ_{AB}(d_{R}^{M})+Δφ_{AB}(R,f_{AB}) (21)
where the first term represents the phase difference term that varies with the distance (d_{R}^{M}) between the mobile tag 2 and the particular receiver (R) and with the frequency difference between tones A and B; and the second component includes the phase error introduced as a result of the non-uniform phase response of the receiver electronics at the two frequencies A and B (which is the only frequency dependent phase error that is not removed in the minimisation calculation performed by the position determination unit 76). Similarly, the phase difference measurement for fixed tag tones C and D calculated from the phase measurements determined by the same receiver R is given by:
Δφ_{CD}=Δφ_{CD}(d_{R}^{fxd})+Δφ_{CD}(R,f_{CD}) (22)

The network calibration unit 78 can use the phase difference measurement for tones C and D to overcome the lack of synchronisation between the receivers for the phase difference measurement between tones A and B in the same way as in the second example discussed above, provided the difference in frequency between tones C and D is the same as the difference in frequency between tones A and B. Therefore, subtracting the phase difference measurement for tones C and D from the phase difference measurement for tones A and B gives:

$$\begin{matrix}{Δϕ}_{AB} - {Δϕ}_{CD} = [ {Δϕ}_{AB} ( {d}_{R}^{M} ) - {Δϕ}_{CD} ( {d}_{R}^{fxd} ) ] + \\ [ {Δϕ}_{AB} ( R , {f}_{AB} ) - {Δϕ}_{CD} ( R , {f}_{CD} ) ]\end{matrix} \qquad ( 23 )$$

The term in the first brackets resynchronises the measurement to a common clock to overcome the lack of synchronisation between the receivers 3 and the term in the second brackets is the unwanted phase error caused by the non-uniform phase response of the receivers 3. It is this second term which must also be removed by the network calibration unit 78.

As discussed above, the network calibration unit 78 does this by using the phase measurements obtained from the replicated tones A and B, periodically transmitted by the fixed tags 5. In particular, when the position processor 4 receives the phase measurements from the second chirp 255 transmitted by the fixed tag 5, it calculates equation (23) above except using the phase measurements from the replicated mobile tag 2 tones A and B. In this case, since the fixed tag 5 transmitted both sets of tones and since the frequency spacing between tones A and B and between tones C and D is the same, the term in the first set of brackets in equation (23) will equal zero. This calculation therefore leaves the term in the second brackets which is the unwanted frequency dependent error introduced by the receiver electronics. The position processor 4 therefore stores this “additional calibration value” in the network calibration unit 78 and subtracts it from the appropriate phase difference measurement determined in equation (23) for the phase measurements for tones A and B when transmitted by the corresponding mobile tag 2. The subtraction of this additional calibration value should remove this frequency dependent error from the phase difference measurement, leaving the resynchronised term that depends on the distance between the mobile tag 2 and the corresponding receiver 3.

In this embodiment, each time the fixed tag 5 transmits tones A and B, the position processor recalculates the additional calibration value for tones A and B and uses it to update a running average (which is actually used as the “additional calibration value”), so that slowly varying changes in the phase response of the receivers 3 will be tracked and removed from the mobile tag phase measurements.

As those skilled in the art will appreciate, the description of the calibration unit 78 has been given with respect to the phase measurements obtained from one receiver and for two mobile tag tones A and B. The network calibration unit 78 will store appropriate calibration values in respect of each receiver, each fixed tag 5 and each tone difference measurement that is calculated. In the present embodiment, there are four receivers 3, four mobile tags 2 and two fixed tags 5.

Therefore, since there are three different phase difference measurements that are calculated, the network calibration unit 78 stores 3×4×4×2 (=96) of these “additional calibration” values which are subtracted from the appropriate phase difference measurements received from the phase measurement determination unit 74.

The thus calibrated phase difference measurements are then used by the position determination unit 76 which calculates the position of the four mobile tags 2 relative to the receivers 3. The position determination unit 76 operates in the same way as in the fourth example discussed above and will not be described further here.

Modifications

Although it has been described above to use the tracking system of the present invention to track horses in a horse race, the present invention is also applicable to dog racing, athletics, cycle racing and motor racing for example. The tracking system would be most useful in sports such as horse racing, athletics and dog racing as it is in these races that the small and unintrusive nature of the transmitter which the participant is required to wear or carry will be of greatest benefit.

In the above examples and embodiments, three or four receivers were used to track the position of one or more mobile tags. As those skilled in the art will appreciate, this number of receivers was used in order to be able to calculate the absolute two-dimensional position of the tag relative to the receivers. However, if the position of the tag is constrained then fewer receivers may be used. For example, two receivers may be used in an embodiment similar to the first example if the tag is constrained to move on one side of the receivers.

Similarly, use of any additional receivers can be used to provide a position measurement in three dimensions (i.e. in height as well as in the x and y horizontal directions). As a further alternative, receivers may be deployed around the side of the track and controlled in such a manner that only a few of the receivers nearest to the tag are used at any one time. In such an embodiment, a “handover” process to introduce and remove receivers from the tag position calculation could be used. Such a handover process could take the form of an active system similar to those implemented in cellular telephone networks or as a simple system of estimating from the position and velocity which receivers will be closest and ignoring the data received from the more distant receivers. Whilst the position determining systems described above can operate with two or more receivers, they preferably use as many receivers as possible in order to provide redundancy in the position calculations.

In all of the examples and embodiments described above, the receivers have been fixed and the transmitters have moved relative to the receivers. As those skilled in the art will appreciate, the receivers may also move provided their relative positions are known. However, such an embodiment is not preferred because of the complexity involved in maintaining knowledge of the positions of the different receivers. As a further alternative, the transmitter may be fixed and the receivers may move relative to the transmitters. Such an embodiment could operate in substantially the same way as the embodiment described above provided the receivers are moved in unison.

As a further alternative, the function and operation of the transmitters and the receivers may be reversed so that each tag becomes a receiver and each receiver becomes a transmitter. In this case, the system would operate in a similar manner to the system described in U.S. Pat. No. 5,045,861, except that each of the fixed transmitters would transmit the multi-tone signal and each of the mobile tags would receive the transmitted signal and either process the signals directly or forward the signals on to a remote position processor where the above processing techniques can be used to determine the relative position of the tag relative to the fixed transmitters. The way in which such an embodiment would operate will be apparent to those skilled in the art and a further description thereof shall be omitted.

In the above embodiments, each receiver received the signal transmitted from each tag and calculated phase measurements which it then passed to a central processing station. The central processing station then calculated phase difference measurements and used these phase difference measurements to calculate the position of the tag relative to the receivers. In an alternative embodiment, the phase difference calculations may be performed in the respective receivers. Such an embodiment is not preferred, however, since it increases the amount of processing that each receiver must perform.

In the above embodiments, each of the receivers received the signal transmitted by each of the tags and processed the received signal to determine phase measurements for the signal. As those skilled in the art will appreciate, it is not essential for these phase measurements to be carried out at the respective receivers. The processing may be carried out by the position processor or by some other intermediate calculating station. All that the receivers have to do is provide a “snapshot” of the signal that they receive. The remaining processing can be carried out elsewhere.

Where it has been described with reference to the specific embodiments to transmit the chirps within the frequency band from 2.4 GHz to 2.485 GHz, this should not be viewed as limiting, any transmission frequency can be used.

Although it has been described above with reference to the first example to provide a range of 300 metres and with respect to the fourth example to provide a range of 3,000 metres, these ranges should not be construed as limiting the present invention. The range of the tracking system may be determined by choosing appropriate frequency difference pairs to cover the desired measurement area.

While it has been described above with reference to the first example that the FPGA will provide data describing the start phase for each tone in a given chirp to the DDS, this is not essential. As an alternative, the DDS may be able to calculate the start phase itself or to continue the generation of the signal and merely not to output it when it is not required and thus the start phase information would not be supplied by the FPGA to the DDS.

In the above embodiments, the tones of each chirp were transmitted alternately. As those skilled in the art will appreciate, this is not essential. The tones may be transmitted simultaneously or in any sequence.

Although it has been described above with reference to the fourth example to have a chirp structure as described with reference to FIG. 15, other chirp structures and relative frequencies of tones within the chirp may be used. For example, a chirp having the following seven tones with frequencies relative to a centre frequency of +0.1 MHz, 0 MHz, −10 MHz, +2.5 MHz, −9.5 MHz, 0 MHz and +0.5 MHz respectively may be used. Such a chirp structure would provide one measurement with a difference of 0.1 MHz, two measurements with a difference of 0.5 MHz, four measurements with a difference of 2.5 MHz and eight measurements with a difference of 10 MHz. This chirp structure provides a more gradual transition between different wavelengths than the chirp structure described with reference to the fourth example. It also comprises more tones and a longer actual measurement period (assuming that the length of each tone within the chirp is unchanged) thereby providing a small improvement in signal to noise ratio (SNR). The use of 8 difference frequencies of around 10 MHz would provide an improved resolution over the fourth example. Double the number of frequency differences and half the wavelength should yield a four times improvement. The use of two intermediate stages at 0.5 MHz and 2.5 MHz should improve the robustness of position acquisition by increasing position resolution thus reducing cycle count ambiguities. Also, the use of the 2.5 MHz difference-will provide an intermediate fallback in the event that signal quality is too poor to use the 10 MHz difference signals.

Although it has been described above with reference to the embodiment that each chirp contains a unique ID tone, it would alternatively be possible to incorporate a data carrying tone into the chirp onto which data including the tag ID could be modulated using a conventional data modulation technique. This arrangement would also provide for additional data to be transmitted with each chirp, for example battery power or other operating conditions.

Although it has been described above with reference to the specific embodiments to use a duration of 48 or 96 frames for each location tone within a chirp, this is not restrictive and other durations are possible. Increasing the tone duration provides an increase in SNR for that tone, and if all tones are extended in duration such that the chirp has greater duration, then the chirp SNR will also be increased. Decreasing the tone duration provides a smaller collision probability when multiple tags are transmitting on the same frequencies as if each chirp is shorter in duration, then there is less chance of it colliding in time with another chirp.

Although it has been described above in the examples that the DDS generating the tones in the tags performs a simple switching operation between the tones, a more complex switching operation could be utilised. For example, where a “hard” ON-OFF switch is used between the tones this has the effect of broadening the spectrum as though it were an FSK system with extended side lobes on approximately 30 kHz spacing (assuming a 0.3 microsecond switching rate). In the case of a system where only a small number of tags are transmitting this is not a serious problem, however in a system where a large number of tags are transmitting this could cause significant interference between the chirps from different tags. It is therefore possible to shape each tone transmission. For example, Gaussian shaping may be used such that the amplitude of each tone will be Gaussian shaped across the duration of the tone. If a Gaussian filter with a bandwidth equivalent to one tone period with a Gaussian shaping factor of between 0.7 and 1.0 is used, the central 0.2 milliseconds of a 0.3 milliseconds tone has sufficient amplitude to be utilised for phase measurement, whilst achieving good suppression of spectral side lobes caused by tone switching. Such chirp shaping would not improve system accuracy significantly, however it would enable the use of a large number of tags. The shaping would also help to ensure that the transmitted spectrum is contained within the desired band thereby providing some SNR improvement. It would also help with compliance with IEEE 802.11 Regulations and reduce the likelihood of intermodulation distortion in the transmitter.

Where it has been described above with reference to the embodiment to pass the sampled, mixed and decimated input data directly to a complex FFT, further processing (such as windowing the data) could be introduced to improve performance. For example, without windowing the data or overlapping the data the discrimination between FFT bins is not high and the system is less well suited for a situation where chirps from different tags are being received simultaneously in different frequency bins and good near-far performance needs to be attained. For example, it would be possible to implement a 14 MHz system reference clock, and a 14 bit ADC which gives up to 80 dB dynamic range, allowing for 54 dB of near-far separation allowing for a minimum of 26 dB SNR. This provides a 500:1 physical range under unobstructed line of sight conditions which, for example, could be implemented as a 6 metre to 3,000 metre range capability. This would produce a data stream into the signal processing block at 28 megasamples per second in I and Q having a bandwidth of 22.4 MHz. A 1024 point FFT operating on that data stream would give bin widths of approximately 27 kHz, since the chirp tones are arranged to rely on approximately 50 kHz spacing which is equal to twice the bin width it would be necessary to achieve a bin+1 attenuation of close to 80 dB. Even with careful data windowing this is difficult to achieve using an FFT. An alternative to the FFT is to use a direct implementation such as an FIR filter bank.

Although it has been described above with reference to the specific embodiments to use a fixed tag located at a known location within the domain of the tracking system, it is possible to modify the location of the fixed tags such that each fixed tag is a single joint entity with a corresponding one of the receivers. This results in the positions of the fixed tags and the receivers becoming the same in the location mathematics but is also means that no separate fixed tags are required when deploying the system. This also means that there are as many fixed tags as there are receivers. However, with the fixed tags and the receivers each sharing the same clock, the calibration of the receiver network to a single network clock (that can be one, any or some average of the receiver clocks) is much simpler than the technique described above with reference to the embodiment. This, therefore, reduces the computational load on the position processor since sets of position equations are now only received for each receiver and each measurement frequency and it is not necessary to multiply-by the number of fixed tags. In addition, the use of a whole network of fixed tags gives a mesh of propagation paths cris-crossing the area of coverage with complete inter-linkage between receivers. Using the entire mesh of paths to obtain the network reference clock will improve system performance.

Although it has been described above with reference to the examples that the link between the receivers and the position processor is established using a wireless TCP/IP network, that case is not limiting and any suitable cabled or wireless network using any suitable network protocol may be used to establish the receiver to position processor links.

Although it has been described above to use an FPGA and DDS to generate the tone signals within the tags, any method of generating the tones in a stable phase-continuous manner may be used. An example of an alternative method would be to use a crystal oscillator at each of the required frequencies to generate the tones.

In the above embodiments, the or each transmitter transmitted a multi-tone signal in which the frequency spacing between the tones was known in advance. As those skilled in the art will appreciate, this is not essential. The results of the FFT analysis performed in the receivers can identify the frequencies of the transmitted tones and hence identify the spacing therebetween.

Although the embodiments described above have used computer apparatus and processes performed in computer apparatus, the invention also extends to computer programs, particularly computer programs on or in a carrier, adapted for putting the invention into practice. The program may be in the form of source code, object code, a code intermediate source and object code such as any partially-compiled form, or in any other form suitable for use in the implementation of the processes according to the invention. The carrier may be any entity or device capable of carrying the program. For example, the carrier may comprise a storage medium, such as a ROM, for example a CD-ROM or a semi-conductor ROM, or a magnetic recording medium, for example a floppy disc or hard disc. Further, the carrier may be a transmissible carrier such as an electrical or optical signal which may be conveyed via electrical or optical cable or by radio or other means.

In the above embodiments, each of the transmitters transmitted a multi-tone signal. As those skilled in the art will appreciate, each of the tones could equally be a pseudo-noise code signal or any other signal with defined and repeatable phase characteristics.

In the above embodiments, the transmitted signals have been radio frequency signals. As those skilled in the art will appreciate, other frequencies of electro-magnetic waves (such as microwave or optical waves) could be used. Further, instead of electromagnetic waves, the transmitters may transmit acoustic signals, with the receivers using acousto-electrical transducers to detect the transmitted acoustic waves.

In the above embodiment, a number of fixed tags were provided to overcome problems associated with the lack of synchronisation between the clocks in the mobile tags and the clocks in the base stations and also to overcome the problem associated with the base stations introducing a frequency dependent phase shift into the received signals. As discussed above, these fixed tags are not essential if the clocks in the mobile tags and the base stations are synchronised and if the base stations do not introduce this frequency dependent phase offset.

In the above embodiment, a new chirp structure for both the mobile tags and the fixed tags was proposed. As those skilled in the art will appreciate, it is not essential to employ both these novel chirp structures in the same embodiment. For example, the new symmetric structure of the chirps transmitted by the mobile tags may be used in an embodiment which does not include fixed tags or in an embodiment where the fixed tags operate in the same way as in the fourth example discussed above. Similarly, the mobile tags may be arranged to transmit a chirp structure similar to that shown in FIG. 15, but with the fixed tag operating to transmit the novel pairs of chirps in the manner described above. Additionally, it is not essential that the fixed tags replicate the tones transmitted by the mobile tags. This is only preferred since it allows frequency dependent errors introduced by the receiver to be removed from the calculations.

1. A racing transmitter for use in a system used to track one or more competitors or equipment in a race event, the racing transmitter comprising:
a clock for generating a clock signal;
a generator operable to generate a transmission signal using the generated clock signal, the transmission signal including a temporal sequence of at least three frequency components having a frequency spacing therebetween; and
an output operable to transmit the transmission signal;
wherein said generator is arranged so that the duration of the frequency components having the greatest frequency separation therebetween is longer than the duration of the or each other frequency component in the sequence.

2. A racing transmitter according to claim 1, wherein said generator is arranged so that the frequency components having the greatest frequency separation therebetween are adjacent each other in the temporal sequence.

3. A racing transmitter according to claim 1, wherein said generator is operable to generate pulses of said transmission signal, each pulse including said temporal sequence of said at least three frequency components.

4. A racing transmitter according to claim 3, wherein said generator is operable to generate pairs of said pulses of transmission signal and wherein said output is operable to transmit said pairs of pulses so that a time interval between the pulses of a pair is less than a time interval between adjacent pairs of pulses.

5. A racing transmitter according to claim 4, wherein said generator is arranged so that one of the pulses within said pairs of pulses includes first and second temporal sequences of frequency components and wherein the frequency components in the first temporal sequence are different to the frequency components in the second temporal sequence.

6. A racing transmitter according to claim 5, wherein said generator is arranged so that said first and second temporal sequences of frequency components are contiguous within said pulse.

7. A racing transmitter according to claim 5, wherein said generator is arranged so that the second pulse in the pair of pulses includes said first and second temporal sequences of frequency components.

8. A racing transmitter according to claim 5, wherein said generator is arranged so that one of said first and second temporal sequences of frequency components is the same as the temporal sequence of frequency components in the other pulse of the pair.

9. A racing transmitter according to claim 5, wherein said generator is arranged so that the second temporal sequence of frequency components comprises different frequency components in adjacent pairs of pulses.

10. A racing transmitter according to claim 1, wherein said generator comprises a frequency synthesiser which is operable to generate frequencies within a predetermined frequency band and a programmable memory device which stores data defining the frequencies to be synthesised by said synthesiser.

11. A racing transmitter according to claim 1, wherein the frequency components are contiguous within said temporal sequence.

12. A racing transmitter according to claim 1, wherein said generator is operable to generate a transmission signal including an ID frequency component which identifies the transmitter to a receiver.

13. A racing transmitter for use in a system used to track one or more competitors or equipment in a race, the racing transmitter comprising:
a clock for generating a clock signal;
a generator operable to generate pulses of a transmission signal using the generated clock signal, each pulse of transmission signal including a sequence of a plurality of frequency components having a frequency spacing therebetween; and
an output operable to transmit the pulses of transmission signal;
wherein said generator is arranged to generate pairs of said pulses of transmission signal and wherein said output is operable to transmit said pairs of pulses so that a time interval between the pulses of a pair is less than a time interval between adjacent pairs of pulses.

14. A racing transmitter for use in a system used to track one or more competitors or equipment in a race, the racing transmitter comprising:
a clock for generating a clock signal;
a generator operable to generate pulses of a transmission signal using the generated clock signal, each pulse of transmission signal including a sequence of a plurality of frequency components having a frequency spacing therebetween; and
an output operable to transmit the pulses of transmission signal;
wherein said generator is operable to generate pulses of transmission signal including first and second temporal sequences of frequency components, wherein the frequency components in the first temporal sequence are different to the frequency components in the second temporal sequence, wherein the frequency components in the first temporal sequence are the same within said pulses and wherein the frequency components in the second temporal sequence are different in adjacent said pulses.

15. A racing transmitter for use in a system used to track one or more competitors or equipment in a race event, the racing transmitter comprising:
a clock for generating a clock signal;
a generator operable to generate a transmission signal using the generated clock signal, the transmission signal including a temporal sequence of different frequency components including at least one start frequency component at least one middle frequency component and at least one end frequency component; and
an output operable to transmit the transmission signal;
wherein said generator is arranged so that the duration of the at least one middle frequency component is longer than the duration of the at least one start frequency component and the at least one end frequency component.

16. A system used to track competitors or equipment in a race, the system comprising:
a first member and a plurality of second members, the first and second members being movable relative to each other and the position of each of the second members relative to the other second members being known;
wherein the first and second members are arranged so that upon the transmission of a signal, there is generated a plurality of received signals each associated with a respective transmission path between a respective second member and the first member;
wherein the first member or each second member comprises a racing transmitter according to claim 1, and wherein the system further comprises:
a processor operable to process each received signal to determine the relative position between the first member and the plurality of second members.

17. A receiver for use with a racing transmitter according to claim 13, the receiver comprising:
a circuit operable to receive said pulses of transmission signal transmitted via said transmitter;
a processor operable to process each frequency component within said sequence of frequency components of each pulse to determine a plurality of phase measures for the phase of the corresponding frequency component at different time points within said frequency component;
a measurement circuit operable to determine, for each frequency component of a current transmission pulse, a phase slope and a phase offset measurement representing the way in which the phase of the frequency component changes within the pulse using the phase measurements determined for the current pulse and one or more phase measurements from a previous pulse.

18. A receiver according to claim 17, wherein said measurement circuit is operable to perform a least squares fit to identify a function that represents the way in which the phase of the frequency component varies during the transmission of the frequency component.

19. An apparatus for determining a set of calibration values for use in a position determining system, the apparatus comprising:
a racing transmitter according to claim 14 and a plurality of receivers for receiving the transmission pulses transmitted by said transmitter;
wherein each receiver is operable to process the received transmission pulses to determine a phase measurement for each frequency component in the first and second sequences of frequency components;
a first phase differencing calculator operable to calculate, for each received signal, a phase difference between the phase measurements of the plurality of frequency components in the first sequence of frequency components, to generate a first set of phase difference measurements;
a second phase differencing calculator operable to calculate, for each received signal, a difference between phase measurements of the frequency components in the second sequence of frequency components, to generate a second set of phase difference measurements; and
a combiner operable to combine the first and second sets of phase difference measurements to generate a set of calibration values.

20. A position processor comprising a receiver operable to receive phase measurements obtained from a plurality of receivers in response to receiving transmission pulses transmitted by the racing transmitter of claim 14, the position processor comprising:
a first phase differencing circuit operable to calculate, for each received signal, a phase difference between the phase measurements of the frequency components in said first sequence of frequency components, to generate a first set of phase difference measurements;
a second phase differencing circuit operable to calculate, for each received signal, a phase difference between the phase measurements of the frequency components in the second sequence of frequency components, to generate a second set of frequency difference measurements; and
a combiner operable to combine the first set of phase difference measurements with the second set of phase difference measurements to generate a set of calibration values for subsequent use in determining the position of a movable member.

21. A method characterised by the step of using a racing transmitter according to claim 1.

22. A method characterised by the step of using a receiver according to claim 17.

23. A method characterised by the step of using a system according to claim 16.

24. A method characterised by the step of using an apparatus according to claim 19.

25. A method characterised by the step of using a position processor according to claim 20.

26. A computer executable instructions product comprising computer executable instructions for causing a programmable computer device to become configured as a receiver according to claim 17.

27. A computer executable instructions product comprising computer executable instructions for causing a programmable computer device to become configured as a position processor according to claim 20.
